(19) United States
(12) Patent Application Publication
(10) Pub. No.: US 2025/0254732 A1
(43) Pub. Date: Aug. 7, 2025

(54) ADAPTING PAGING OCCASIONS IN WIRELESS COMMUNICATION SYSTEMS

(71) Applicant: Samsung Electronics Co., Ltd., Suwon-si (KR)

(72) Inventors: Anil Agiwal, McKinney, TX (US); Shiyang Leng, Allen, TX (US); Kyeongin Jeong, Allen, TX (US); Hongbo Si, Allen, TX (US)

(21) Appl. No.: 19/040,757

(22) Filed: Jan. 29, 2025

Related U.S. Application Data
(60) Provisional application No. 63/550,886, filed on Feb. 7, 2024.
(60) Provisional application No. 63/551,804, filed on Feb. 9, 2024.
(60) Provisional application No. 63/700,267, filed on Sep. 27, 2024.

(51) Int. Cl. H04W 74/0833; H04W 68/02; H04W 72/23

(52) U.S. Cl. CPC H04W 74/0833; H04W 68/02; H04W 72/23

(57) ABSTRACT

A method of operating a UE includes receiving, a configuration for a first SSB pattern, a configuration for a second SSB pattern, and a first RACH configuration, and receiving an indication activating an SSB pattern. The method also includes determining whether the activated SSB pattern is the first SSB pattern, and in response to a determination that the activated SSB pattern is the first SSB pattern: associating a ROs configured by the first RACH configuration to a first plurality of SSBs transmitted according to the first SSB pattern, associating RA preambles configured by the first RACH configuration to the first plurality of SSBs, selecting an SSB from the first plurality of SSBs; selecting, from the ROs, an RO corresponding to the selected SSB, selecting, from the RA preambles, an RA preamble corresponding to the selected SSB; and transmitting the selected RA preamble in the selected RO.

### CROSS-REFERENCE TO RELATED APPLICATION(S) AND CLAIM OF PRIORITY

This application claims priority under 35 U.S.C. § 119(e) to U.S. Provisional Patent Application No. 63/550,886 filed on Feb. 7, 2024, U.S. Provisional Patent Application No. 63/551,804 filed on Feb. 9, 2024, and U.S. Provisional Patent Application No. 63/700,267 filed on Sep. 27, 2024. The above-identified provisional patent applications are hereby incorporated by reference in their entirety.

### TECHNICAL FIELD

This disclosure relates generally to wireless networks. More specifically, this disclosure relates to adapting paging occasions in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for adapting paging occasions in wireless communication systems.

In one embodiment, a user equipment (UE) is provided. The UE includes a transceiver. The transceiver is configured to receive, from a base station (BS), a configuration for a first synchronization signal block (SSB) pattern, a configuration for a second SSB pattern, and a first random access (RA) channel (RACH) configuration, and receive from the BS, an indication activating an SSB pattern. The UE also includes a processor operatively coupled to the transceiver. The processor is configured to determine whether the activated SSB pattern is the first SSB pattern, and in response to a determination that the activated SSB pattern is the first SSB pattern: associate a plurality of RA occasions (ROs) configured by the first RACH configuration to a first plurality of SSBs transmitted according to the first SSB pattern, wherein the association is based on a number of SSBs per RO included in the first RACH configuration; associate a plurality of RA preambles configured by the first RACH configuration to the first plurality of SSBs, wherein the association is based on a number of contention based random access (CBRA) preambles per SSB included in the first RACH configuration; select an SSB from the first plurality of SSBs; select, from the plurality of ROs, an RO corresponding to the selected SSB based on the association between first plurality of SSBs to the plurality of ROs; elect, from the plurality of RA preambles, an RA preamble corresponding to the selected SSB based on the association between the first plurality of SSBs to the plurality of RA preambles; and cause the transceiver to transmit the selected RA preamble in the selected RO.

In another embodiment, a BS is provided. The BS includes a transceiver. The transceiver is configured to transmit a configuration for a first SSB pattern, a configuration for a second SSB pattern, and a first RACH configuration, and transmit an indication activating an SSB pattern. The BS also includes a processor operatively coupled to the transceiver. The processor is configured to determine whether the activated SSB pattern is the first SSB pattern, and in response to a determination that the activated SSB pattern is the first SSB pattern: associate a first plurality of RA occasions (ROs) configured by the first RACH configuration to a first plurality of SSBs transmitted according to the first SSB pattern, wherein the association is based on a number of SSBs per RO included in the first RACH configuration; associate a first plurality of RA preambles configured by the first RACH configuration to the first plurality of SSBs, wherein the association is based on a number of contention based random access (CBRA) preambles per SSB included in the first RACH configuration; and monitor the plurality of ROs for an RA preamble from the plurality of RA preambles.

In yet another embodiment, a method of operating a UE is provided. The method includes receiving, from a BS, a configuration for a first SSB pattern, a configuration for a second SSB pattern, and a first RACH configuration, and receiving from the BS, an indication activating an SSB pattern. The method also includes determining whether the activated SSB pattern is the first SSB pattern, and in response to a determination that the activated SSB pattern is the first SSB pattern: associating a plurality of ROs configured by the first RACH configuration to a first plurality of SSBs transmitted according to the first SSB pattern, wherein the association is based on a number of SSBs per RO included in the first RACH configuration; associating a plurality of RA preambles configured by the first RACH configuration to the first plurality of SSBs, wherein the association is based on a number of CBRA preambles per SSB included in the first RACH configuration; selecting an SSB from the first plurality of SSBs; selecting, from the plurality of ROs, an RO corresponding to the selected SSB based on the association between first plurality of SSBs to the plurality of ROs; selecting, from the plurality of RA preambles, an RA preamble corresponding to the selected SSB based on the association between the first plurality of SSBs to the plurality of RA preambles; and transmitting the selected RA preamble in the selected RO.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 an example DRX Cycle according to embodiments of the present disclosure;

FIG. 5 illustrates an example procedure for determining POs according to embodiments of the present disclosure;

FIGS. 6A-6D illustrate an example of PO determination according to embodiments of the present disclosure;

FIG. 7 illustrates an example bitmap according to embodiments of the present disclosure;

FIG. 8 illustrates another example bitmap according to embodiments of the present disclosure;

FIG. 9 illustrates an example SFN cycle according to embodiments of the present disclosure;

FIG. 10 illustrates an example procedure to determine valid RACH occasions according to embodiments of the present disclosure;

FIGS. 11A-11C illustrate an example PRACH occasion to SSB mapping determination according to embodiments of the present disclosure;

FIG. 12 illustrates another example procedure to determine valid RACH occasions according to embodiments of the present disclosure;

FIG. 13 illustrates another example procedure to determine valid RACH occasions according to embodiments of the present disclosure;

FIG. 14 illustrates another example procedure to determine valid RACH occasions according to embodiments of the present disclosure;

FIG. 15 illustrates an example procedure for LP-WUS operation according to embodiments of the present disclosure; and

FIG. 16 illustrates an example method for adapting paging occasions according to embodiments of the present disclosure.

### DETAILED DESCRIPTION

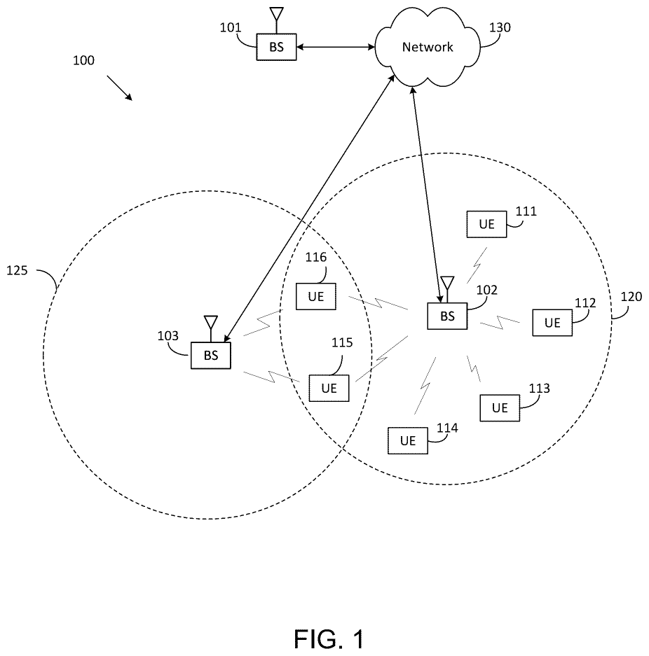

FIGS. 1 through 16, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for adapting paging occasions. In certain embodiments, one or more of the gNBs 101-103 includes circuitry, programing, or a combination thereof, to support adapting paging occasions in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

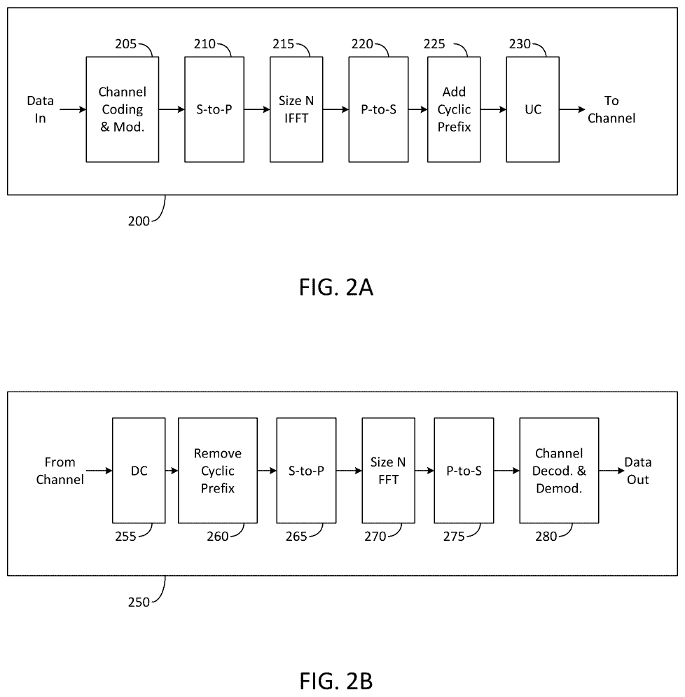

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support adapting paging occasions as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

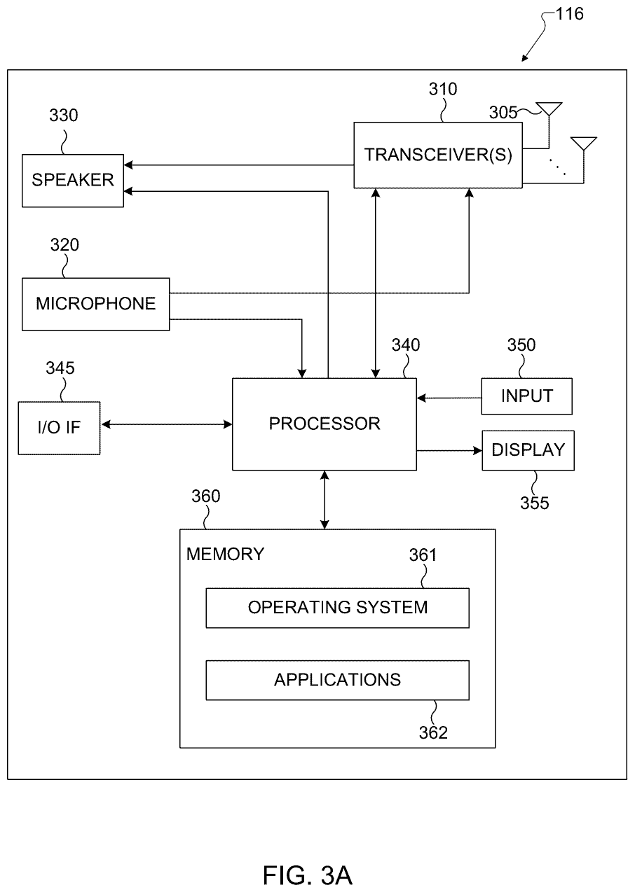

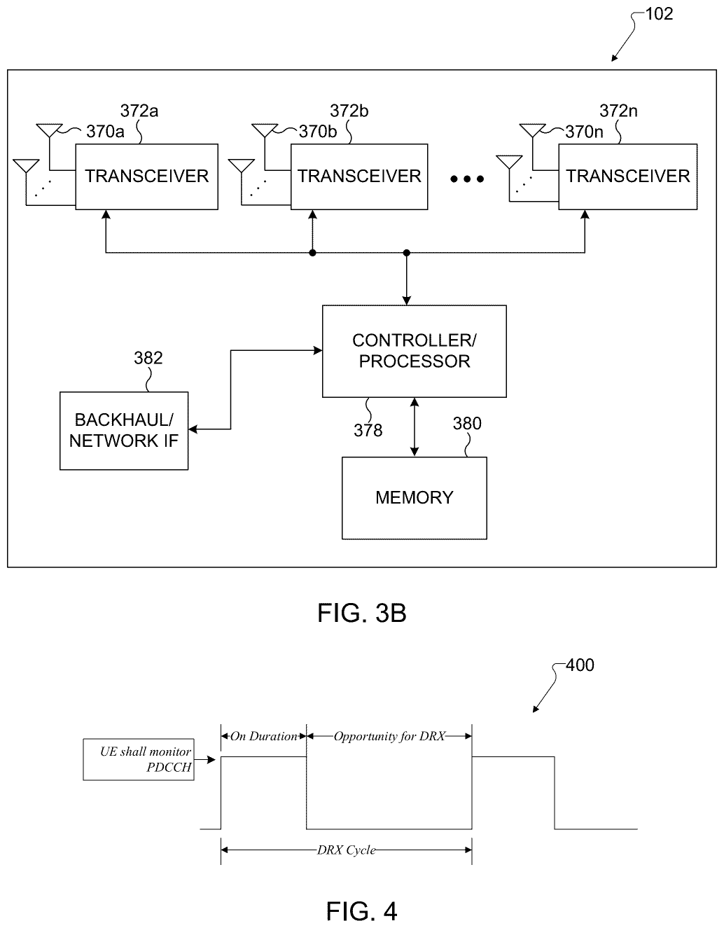

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for adapting paging occasions as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support adapting paging occasions as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G (B5G), 6G) supports not only lower frequency bands but also higher frequency (mmWave) bands, e.g., 10 GHz to 100 GHz bands, so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve the UEs having quite different capabilities depending on the use case and market segment the UE cater service to the end customer. A few example use cases the next generation wireless communication system is expected to address is enhanced Mobile Broadband (eMBB), massive Machine Type Communication (m-MTC), ultra-reliable low latency communication (URLL) etc. The eMBB requirements like tens of Gbps data rate, low latency, high mobility, etc. address the market segment representing conventional wireless broadband subscribers needing internet connectivity everywhere, all the time and on the go. The m-MTC requirements like very high connection density, infrequent data transmission, very long battery life, low mobility address, etc. address the market segment representing the Internet of Things (IoT)/Internet of Everything (IoE) envisioning connectivity of billions of devices. The URLL requirements like very low latency, very high reliability and variable mobility, etc. address the market segment representing industrial automation applications, vehicle-to-vehicle/vehicle-to-infrastructure communication foreseen as one of the enablers for autonomous cars.

In the next generation wireless communication system (e.g., 5G, beyond 5G (B5G), 6G) operating in higher frequency (e.g., mmWave, terahertz) bands, UEs and gNBs communicate with each other using beamforming. Beamforming techniques are used to mitigate propagation path losses and to increase propagation distance for communication at higher frequency bands. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using an RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a transmit (TX) beam. A wireless communication system operating at high frequency uses plurality of narrow TX beams to transmit signals in the cell, as each narrow TX beam provides coverage to a part of cell. The narrower the TX beam, the higher the antenna gain and hence the larger the propagation distance of a signal transmitted using beamforming. A receiver can also generate a plurality of receive (RX) beam patterns of different directions. Each of these receive patterns can be also referred to as a receive (RX) beam.

The next generation wireless communication system (e.g., 5G, beyond 5G (B5G), 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network (CN). NR also supports Multi-RAT Dual Connectivity (MR-DC) operation whereby a UE in the RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in the RRC_CONNECTED state not configured with carrier aggregation (CA)/DC there is only one serving cell comprising the primary cell. For a UE in the RRC_CONNECTED state configured with CA/DC the term ‘serving cells’ is used to denote the set of cells comprising the Special Cell(s) (SpCells) and all secondary cells (SCells). In NR the term Master Cell Group (MCG) refers to a group of serving cells associated with the Master Node, comprising of the primary cell (PCell) and optionally one or more SCells. In NR the term Secondary Cell Group (SCG) refers to a group of serving cells associated with the Secondary Node, comprising the Primary SCG Cell (PSCell) and optionally one or more SCells. In NR, PCell refers to a serving cell in the MCG, operating on the primary frequency, in which the UE either performs the initial connection establishment procedure or initiates the connection re-establishment procedure. In NR for a UE configured with CA, an SCell is a cell providing additional radio resources on top of the SpCell. PSCell refers to a serving cell in the SCG in which the UE performs random access when performing the Reconfiguration with Sync procedure. For Dual Connectivity operation the term SpCell refers to the PCell of the MCG or the PSCell of the SCG. Otherwise, the term Special Cell refers to the PCell.

In the next generation wireless communication system (e.g., 5G, beyond 5G (B5G), 6G) bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a BWP. BA is achieved by configuring a radio resource control (RRC) connected UE with BWP(s) and telling the UE which of the configured BWPs is currently the active one. When BA is configured, the UE can monitor the physical downlink common control channel (PDCCH) only on the one active BWP (i.e., it does not have to monitor PDCCH on the entire downlink (DL) frequency of the serving cell). In the RRC connected state, the UE is configured with one or more DL and uplink (UL) BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-InactivityTimer, by RRC signaling, or by the MAC entity itself upon initiation of Random Access (RA) procedure. Upon addition of an SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both UL and DL. Upon expiry of a BWP inactivity timer, the UE switches the active DL BWP to the default DL BWP or initial DL BWP (if a default DL BWP is not configured).

In the next generation wireless communication system (e.g., 5G, beyond 5G (B5G), 6G), a node B (gNB) or base station in cell broadcast Synchronization Signal and PBCH block (SSB) comprises primary and secondary synchronization signals (PSS, SSS) and system information. System information includes common parameters needed to communicate in the cell. In the next generation wireless communication system (also referred as next generation radio or NR), System Information (SI) is divided into the master information block (MIB) and a number of system information blocks (SIBs) where: The MIB is transmitted on the broadcast channel (BCH) with a periodicity of 80 ms and repetitions made within 80 ms, and the MIBt includes parameters that are used to acquire SIB1 from the cell. The SIB1 is transmitted on the downlink-shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, SIB1 repetition transmission period is 20 ms. For SSB and CORESET multiplexing pattern 2/3, SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which comprises one or several cells and is identified by systemInformationAreaID; The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in the RRC_CONNECTED state, the network can provide system information through dedicated signaling using the RRCReconfiguration message (e.g., if the UE has an active bandwidth part (BWP) with no common search space configured to monitor system information), paging, or upon request from the UE. In the RRC_CONNECTED state, the UE acquires the required SIB(s) only from the PCell. For PSCell and SCells, the network provides the SI by dedicated signaling, (i.e., within an RRCReconfiguration message). Nevertheless, the UE acquires the MIB of the PSCell to get system frame number (SFN) timing of the SCG (which may be different from the MCG). Upon change of relevant SI for the SCell, the network releases and adds the concerned SCell. For the PSCell, the SI can be changed with Reconfiguration with Sync.

In the next generation wireless communication system (e.g., 5G, beyond 5G (B5G), 6G), the physical Downlink Control Channel (PDCCH) is used to schedule DL transmissions on the physical downlink shared channel (PDSCH) and UL transmissions on the physical uplink shared channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to the uplink-shared channel (UL-SCH). In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of physical resource block (PRBs) with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mapping is supported in a CORESET. Polar coding is used for PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G (B5G), 6G), a list of search space configurations is signaled by the gNB for each configured BWP of the serving cell, wherein each search configuration is uniquely identified by a search space identifier. The search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration, where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations are signaled by the gNB for each configured BWP of a serving cell, wherein each CORESET configuration is uniquely identified by a CORESET identifier. The CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. A TCI state indicates the DL TX beam (the DL TX beam is QCLed with SSB/CSI RS of TCI state) used by the gNB for transmission of the PDCCH in the PDCCH monitoring occasions of a search space.

In the next generation wireless communication system (e.g., 5G, beyond 5G (B5G), 6G), a UE can be in one of the following RRC states: RRC IDLE, RRC INACTIVE and RRC CONNECTED. Paging allows the network to reach UEs in the RRC_IDLE and in RRC_INACTIVE state through Paging messages, and to notify UEs in the RRC_IDLE, RRC_INACTIVE and RRC_CONNECTED state of system information changes and ETWS (Earthquake and Tsunami Warning System)/CMAS (Commercial Mobile Alert System) indications through Short Messages. Both Paging messages and Short Messages are addressed with a paging radio network terminal identifier (P-RNTI) on the PDCCH, but while the former is sent on a paging common logical channel (PCCH) (a transport block [TB] carrying the paging message is transmitted over the PDSCH [Physical downlink shared channel])), the latter is sent over the PDCCH directly.

While in the RRC_IDLE state, the UE monitors the paging channels for core network (CN)-initiated paging. While in the RRC_INACTIVE state, the UE monitors paging channels for radio access network (RAN)-initiated paging and CN-initiated paging. A UE need not monitor paging channels continuously though. Paging discontinuous reception (DRX) is defined where the UE in the RRC_IDLE or RRC_INACTIVE state is only required to monitor paging channels during one Paging Occasion (PO) per DRX cycle.

A PO is a set of PDCCH monitoring occasions and can comprise multiple time slots (e.g., subframes or OFDM symbols) where paging DCI (i.e., PDCCH addressed to a P-RNTI) can be sent. One Paging Frame (PF) is one Radio Frame and may contain one or multiple PO(s) or a starting point of a PO. A PO associated with a PF may start in the PF or after the PF.

In multi-beam operations, the UE assumes that the same paging message and the same Short Message are repeated in all transmitted beams, and thus the selection of the beam(s) for the reception of the paging message and Short Message is up to UE implementation. The paging message is the same for both RAN initiated paging and CN initiated paging. The UE initiates the RRC Connection Resume procedure upon receiving RAN initiated paging. If the UE receives a CN initiated paging in the RRC_INACTIVE state, the UE moves to the RRC_IDLE state and informs the network access stratum (NAS).

The PF and PO for paging are determined (by the UE and base station e.g., gNB) by the following formulae:

System frame number (SFN) for the PF is determined by:

(SFN+PF_offset)mod T=(T div N)*(UE_ID mod N)

Index (i_s), indicating the index of the PO is determined by:

i_s=floor(UE ID/N)mod Ns

The PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI (or SIB1).

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (is =0) or the second half frame (is =1) of the PF.

When SearchSpaceId other than 0 is configured for pagingSearchSpace, the UE monitors the (is +1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (is +1)th PO is the (is +1)th value of thefirstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

The following parameters are used for the calculation of PF and i_s above:
T: DRX cycle of the UE.
N: number of total paging frames in T; N is one of T, T/2, T/4, T/8, T/16
Ns: number of paging occasions for a PF; NS is one of 1, 2, 4
PF_offset: offset used for PF determination

### UE_ID:

If the UE operates in enhanced DRX (eDRX):
5G-S-TMSI (5G serving temporary mobile subscriber identity) mod 4096 otherwise:
5G-S-TMSI mod 1024

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter firstPDCCH-MonitoringOccasionOfPO is signaled in SIB1 for paging in the BWP configured by initialDowninkBWP. For paging in a DL BWP other than the BWP configured by initialDowninkBWP, the parameter first-PDCCH-MonitoringOccasionOfPO is signaled in the corresponding BWP configuration. If the UE has no 5G-S-TMSI, for instance when the UE has not yet registered onto the network, the UE shall use as default identity UE_ID=0 in the PF and is formulas above.

In order to reduce UE power consumption due to false paging alarms, the group of UEs monitoring the same PO can be further divided into multiple subgroups. With subgrouping, a UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

Paging with CN assigned subgrouping is used in the cell which supports CN assigned subgrouping. A UE supporting CN assigned subgrouping in the RRC_IDLE or RRC_INACTIVE state can be assigned a subgroup ID (between 0 to 7) by an access and mobility management function (AMF) through NAS signaling.

If the UE is not configured with a CN assigned subgroup ID, or if the UE configured with a CN assigned subgroup ID is in a cell supporting only UE_ID based subgrouping, the subgroup ID of the UE is determined by the formula below:

$$SubgroupID = ( floor ( UE\_ID / ( N * Ns ) ) mod subgroupsNumForUEID ) + ( subgroupsNumPerPO - subgroupsNumForUEID ) ,$$

where:
N: number of total paging frames in T, which is the DRX cycle of RRC_IDLE state
Ns: number of paging occasions for a PF
UE_ID: 5G-S-TMSI mod X, where X is 32768, if eDRX is applied; otherwise, X is 8192
subgroupsNumForUEID: number of subgroups for UE_ID based subgrouping in a PO, which is broadcasted in system information

The UE monitors one PEI occasion per DRX cycle. A PEI occasion (PEI-O) is a set of PDCCH monitoring occasions (MOs) and can comprise multiple time slots (e.g., subframes or OFDM symbols) where a PEI can be sent. In multi-beam operations, the UE assumes that the same PEI is repeated in all transmitted beams, and thus the selection of the beam(s) for the reception of the PEI is up to UE implementation. The time location of a PEI-O for the UE's PO is determined by a reference point and an offset:
The reference point is the start of a reference frame determined by a frame-level offset from the start of the first PF of the PF(s) associated with the PEI-O, provided by pei-FrameOffset in SIB1; The first PF of the PFs associated with the PEI-O is provided by (SFN for PF) −floor (i_{PO}/Ns)*TT/N; where i_{PO}=((UE_IDmodN)·Ns+i_s)modN_{PO}^{PEI} is a paging occasion index, N_{PO}^{PEI}, is signaled by po-NumPerPEI.
The offset is a symbol-level offset from the reference point to the start of the first PDCCH MO of this PEI-O, provided by firstPDCCH-MonitoringOccasionOfPEI-O in SIB1.

The PDCCH MOs for PEI are determined according to pei-SearchSpace, pei-FrameOffset, firstPDCCH-MonitoringOccasionOfPEI-O and nrofPDCCH-MonitoringOccasionPerSSB-InPO if configured. UE determines first PDCCH MO for PEI-O based on pei-FrameOffset and firstPDCCH-MonitoringOccasionOfPEI-O,

In the next generation wireless communication system (e.g., 5G, beyond 5G (B5G), 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state. Several types of random-access procedure are supported such as contention based random access, contention free random access and each of these can be one of 2 step or 4 step random access.

In contention based random access (CBRA), also referred as 4 step CBRA, the UE first transmits a Random Access preamble (also referred to as Msg1) and then waits for a Random access response (RAR) in the RAR window. The RAR is also referred to as Msg2. A next generation node B (gNB) transmits the RAR on the physical downlink shared channel (PDSCH). A PDCCH scheduling the PDSCH carrying the RAR is addressed to a RA-radio network temporary identifier (RA-RNTI). The RA-RNTI identifies the time-frequency resource (also referred to as a physical RA channel [PRACH] occasion or PRACH transmission [TX] occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted the Msg1, (i.e., RA preamble); 0≤s_id≤14; t_id is the index of the first slot of the PRACH occasion (0≤t_id≤80); f_id is the index of the PRACH occasion within the slot in the frequency domain (0≤f_id<8), and ul_carrier_id is the UL carrier used for Msg1 transmission (0 for a normal UL [NUL] carrier and 1 for a supplementary UL [SUL] carrier. Several RARs for various Random-access preambles detected by the gNB can be multiplexed in the same RAR media access control (MAC) protocol data unit (PDU) by the gNB. A RAR in MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and the UE has not yet transmitted the RA preamble for a configurable (configured by the gNB in a RACH configuration) number of times, the UE goes back to the first step (i.e., select a random access resource [preamble/RACH occasion]) and transmits the RA preamble. A backoff may be applied before going back to first step.

If the RAR corresponding to its RA preamble transmission is received, the UE transmits a message 3 (Msg3) in the UL grant received in the RAR. The Msg3 includes a message such as an RRC connection request, RRC connection re-establishment request, RRC handover confirm, scheduling request, SI request etc. It may include the UE identity (i.e., cell-radio network temporary identifier [C-RNTI] or system architecture evolution [SAE]-temporary mobile subscriber identity [S-TMSI] or a random number). After transmitting the Msg3, the UE starts a contention resolution timer. While the contention resolution timer is running, if UE receives a physical downlink control channel (PDCCH) addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (first X bits of common control channel [CCCH] service data unit [SDU]transmitted in the Msg3), contention resolution is considered successful, the contention resolution timer is stopped, and the RA procedure is completed. If the contention resolution timer expires and the UE has not yet transmitted the RA preamble for a configurable number of times, the UE goes back to the first step (i.e., select random access resource [preamble/RACH occasion]) and transmits the RA preamble. A backoff may be applied before going back to first step.

For performing CBRA, a RACH configuration is signaled in system information (i.e., SIB 1) and in dedicated RRC signaling. RACH configuration in SIB 1 is used by UE in RRC IDLE and RRC INACTIVE.
A contention based RACH configuration includes prach-ConfigurationIndex, which indicates the available set of PRACH occasions for the transmission of the Random Access Preamble. The number of PRACH occasions in a PRACH configuration period is pre-defined for each PRACH configuration index. The PRACH configuration period for each PRACH configuration index is also pre-defined. A pre-defined PRACH configuration table list a number of configurations, wherein each configuration indicates a number of PRACH occasions in the PRACH configuration period, the PRACH configuration period, and the location of PRACH occasions in the PRACH configuration period. The PRACH configuration index is an index to an entry in this PRACH configuration table.
A contention based RACH configuration also include ssb-perRACH-OccasionAndCB-PreamblesPerSSB. ssb-perRACH-OccasionAndCB-PreamblesPerSSB indicates CB-PreamblesPerSSB (R) and ssb-perRACH-Occasion (N).
Based on ssb-perRACH-Occasion and SSBs indicated by ssb-PositionsInBurst in the cell, valid PRACH occasions (for paired spectrum or supplementary uplink band all PRACH occasions are valid) amongst the PRACH occasions configured by prach-ConfigurationIndex are mapped to SSBs in following order:
   First, in increasing order of preamble indexes within a single PRACH occasion
   Second, in increasing order of frequency resource indexes for frequency multiplexed PRACH occasions
   Third, in increasing order of time resource indexes for time multiplexed PRACH occasions within a PRACH slot
   Fourth, in increasing order of indexes for PRACH slots
An association period, starting from frame 0, for mapping SSBs indexes to PRACH occasions is the smallest value in the set determined by the PRACH configuration period according to Table 1 below, such that transmitted SSBs indicated by ssb-PositionsInBurst are mapped at least once to the PRACH occasions within the association period. If after an integer number of SSBs to PRACH occasions mapping cycles within the association period there is a set of PRACH occasions or PRACH preambles that are not mapped to SSBs, no SSBs are mapped to the set of PRACH occasions or PRACH preambles.

TABLE 1

| PRACH configuration period | Association period (number of |
|---|---|
| (msec) | PRACH configuration periods) |
| 10 | {1, 2, 4, 8, 16} |
| 20 | {1, 2, 4, 8} |
| 40 | {1, 2, 4} |
| 80 | {1, 2} |
| 160 | {1} |

If N<1, one SSB is mapped to 1/N consecutive valid PRACH occasions and R contention based preambles with consecutive indexes associated with the SSB per valid PRACH occasion start from preamble index 0. If N≥1, R contention based preambles with consecutive indexes associated with SSB n, 0≤n≤N−1, per valid PRACH occasion start from preamble index n·N_{preamble}^{total}/N where N_{preamble}^{total} is provided by totalNumberOfRA-Preambles and is an integer multiple of N. totalNumberOfRA-Preambles is signaled by gNB in RACH configuration.

Contention free random access (CFRA), also referred to as legacy CFRA or 4 step CFRA, is used for scenarios such as handover where low latency is required, timing advance establishment for secondary cell (Scell), etc. An evolved node B (eNB) assigns to the UE a dedicated Random access preamble. The UE transmits the dedicated RA preamble. The eNB transmits the RAR on a PDSCH addressed to a RA-RNTI. The RAR conveys an RA preamble identifier and timing alignment information. The RAR may also include an UL grant. The RAR is transmitted in RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if a PDCCH addressed to a C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

In the next generation wireless communication system (e.g., 5G, beyond 5G (B5G), 6G), the PDCCH monitoring activity of the UE in the RRC connected mode is governed by DRX, BA, DCP and cell DTX. When DRX is configured, the UE does not have to continuously monitor PDCCH. DRX is characterized by the following:
on-duration: duration that the UE waits for, after waking up, to receive PDCCHs. If the UE successfully decodes a PDCCH, the UE stays awake and starts the inactivity timer;
inactivity-timer: duration that the UE waits to successfully decode a PDCCH, from the last successful decoding of a PDCCH, failing which it can go back to sleep. The UE shall restart the inactivity timer following a single successful decoding of a PDCCH for a first transmission only (i.e., not for retransmissions);
retransmission-timer: duration until a retransmission can be expected;
cycle: specifies the periodic repetition of the on-duration followed by a possible period of inactivity;
active-time: total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

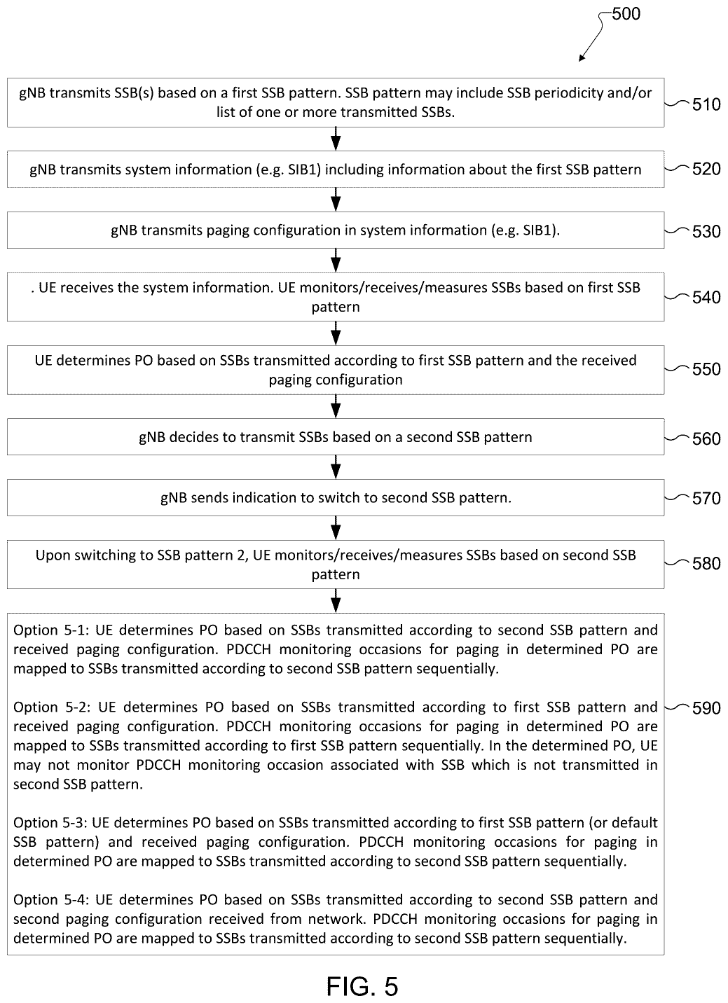

FIG. 4 illustrates an example DRX Cycle 400 according to embodiments of the present disclosure. The embodiment of a DRX cycle of FIG. 4 is for illustration only. Different embodiments of a DRX cycle could be used without departing from the scope of this disclosure.

Although FIG. 4 illustrates one example DRX cycle 400, various changes may be made to FIG. 4. For example, various changes to on duration, the opportunity for DRX, etc. could be made, etc. according to particular needs.

In addition, the UE may be indicated, when configured accordingly, whether it is required to monitor or not the PDCCH during the next occurrence of the on-duration by a downlink control information of power saving (DCP) monitored on the active BWP. If the UE does not detect a DCP on the active BWP, it does not monitor the PDCCH during the next occurrence of the on-duration, unless it is explicitly configured to do so in that case. A UE can only be configured to monitor DCP when connected mode DRX is configured, and at occasion(s) at a configured offset before the on-duration. More than one monitoring occasion can be configured before the on-duration. The UE does not monitor DCP on occasions occurring during active-time, measurement gaps, BWP switching, or when it monitors response for a CFRA preamble transmission for beam failure recovery, in which case it monitors the PDCCH during the next on-duration. If no DCP is configured in the active BWP, the UE follows normal DRX operation. When CA is configured, DCP is only configured on the PCell.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are on-duration and inactivity-timer.

RRC controls DRX operation by configuring the following parameters:
drx-onDurationTimer: the duration at the beginning of a DRX cycle;
drx-SlotOffset: the delay before starting the drx-onDurationTimer;
drx-InactivityTimer: the duration after the PDCCH occasion in which a PDCCH indicates a new UL, DL or SL transmission for the MAC entity;
drx-RetransmissionTimerDL (per DL HARQ process except for the broadcast process): the maximum duration until a DL retransmission is received;
drx-RetransmissionTimer UL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-NonIntegerLongCycleStartOffset (optional): the Long DRX cycle and drx-StartOffset which defines the subframe where the Long and Short DRX cycle start, when the length of the Long DRX cycle and/or the short DRX cycle is not an integer;
drx-ShortCycle (optional): the Short DRX cycle;
drx-NonIntegerShortCycle (optional): the Short DRX cycle whose length is not an integer;
drx-ShortCycle Timer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
drx-RetransmissionTimerSL (per sidelink process): the maximum duration until a grant for SL retransmission is received;
drx-HARQ-RTT-TimerSL (per sidelink process): the minimum duration before an SL retransmission grant is expected by the MAC entity;
drx-LastTransmissionUL (optional): the configuration to start drx-HARQ-RTT-TimerUL after the last transmission within a bundle;
ps-Wakeup (optional): the configuration to start associated drx-onDurationTimer in case DCP is monitored but not detected;
ps-TransmitOtherPeriodicCSI (optional): the configuration to report periodic CSI that is not L1-RSRP on PUCCH during the time duration indicated by drx-onDurationTimer in case DCP is configured but associated drx-onDurationTimer is not started;
ps-TransmitPeriodicL1-RSRP (optional): the configuration to transmit periodic CSI that is L1-RSRP on PUCCH during the time duration indicated by drx-onDurationTimer in case DCP is configured but associated drx-onDurationTimer is not started;
downlinkHARQ-FeedbackDisabled (optional): the configuration to disable HARQ feedback per DL HARQ process;
uplinkHARQ-Mode (optional): the configuration to set HARQmodeA or HARQmodeB per UL HARQ process;
disableCG-RetransmissionMonitoring (optional): the configuration to disable starting drx-HARQ-RTT-TimerUL for UL transmission over a configured uplink grant;
drx-TimeReferenceSFN (optional): the reference SFN used in determining the start time of DRX on durations when short and/or long DRX cycle is not an integer.

The following UE variable is used for the DRX operation if drx-NonIntegerLongCycleStartOffset is configured:
DRX SFN COUNTER: the counter that increments when SFN changes to 0. This counter can be implemented with a maximum value of 65535.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-NonIntegerLongCycleStartOffset, drx-ShortCycle (optional), drx-NonIntegerShortCycle (optional), drx-ShortCycleTimer (optional), drx-HARQ-RTT-TimerDL, and drx-HARQ-RTT-TimerUL.

UEs periodically wake up once per DRX cycle, which dominates the power consumption in periods with no signaling or data traffic. Power consumption could be dramatically reduced by using a wake-up signal to trigger the main radio (MR) and a separate low power wakeup receiver (LR) which has the ability to monitor a wake-up signal with ultra-low power consumption. The low power wakeup receiver (LR) is expected to consume 1/100 of power consumed by MR. MR works for data transmission and reception, which can be turned off or set to deep sleep unless it is turned on. It is expected that a UE in the RRC_IDLE or RRC_INACTIVE state monitor a low power wakeup signal (LP WUS) using the LR if the UE and camped cell supports the LP WUS. The gNB transmits the low power wakeup signal to send RAN paging or CN paging to the UE or SI/emergency notifications to UE. If the LP WUS is received:
The UE monitors PEI in its PEI-O. The UE monitors PEI (using MR) and/or subsequently the UE monitors its PO in its PF (using MR) and receives the paging message (if scheduled by the monitored PO) if the PEI indicates paging for the UE/UE specific paging subgroup. The UE determines its PEI-O, PF/PO as described herein.
OR
The UE monitors its PO (e.g., if the cell/UE does not support PEI) in its PF. After PO monitoring, the UE receives a PDSCH (if scheduled by DCI in the monitored PO) including the paging message. The UE determines its PF/PO as in legacy

The payload of LP WUS may include one or more of the following:
information on which user(s) is/are targeted by the LP-WUS:
   e.g., UE-group, -subgroup or -ID
cell information
SI change and ETWS/CMAS information
tracking area information, RAN area information.

Network energy saving is of great importance for environmental sustainability, to reduce environmental impact (greenhouse gas emissions), and for operational cost savings. As wireless communication systems are becoming pervasive across industries and geographical areas, handling more advanced services and applications requiring very high data rates (e.g., XR), networks are becoming denser, use more antennas, use larger bandwidths and use more frequency bands. Novel solutions to improve network energy savings are desirable to control the environmental impact of wireless communications systems.

Energy consumption has become a key part of the operators' OPEX. The energy cost on mobile networks accounts for ˜23% of the total operator cost. Most of the energy consumption comes from the radio access network, and in particular from the Active Antenna Unit (AAU), with data centers and fiber transport accounting for a smaller share. The power consumption of a radio access can be split into two parts: the dynamic part which is only consumed when data transmission/reception is ongoing, and the static part which is consumed all the time to maintain the necessary operation of the radio access devices, even when data transmission/reception is not on-going.

One or more synchronization signal blocks (SSBs) are periodically transmitted in a cell. SSBs are periodically transmitted within a half frame (i.e., 5 ms window). The SSB includes a primary synchronization signal (PSS), secondary synchronization signal (SSS) and Physical broadcast channel (PBCH). Time-domain positions of transmitted SSBs within a half frame (i.e., 5 ms window) are semi-statically configured. Further, the UE assumes a single periodicity for the transmitted SSBs. The transmission of common signal and channels may limit the gNB's ability to use (deeper) sleep modes to save energy. Currently, the system information (SI) update mechanism can adapt the parameters in the cell, such as those associated with downlink common and broadcast signals, such as SSB, SI etc.

Techniques to adapt the transmission pattern of downlink common and broadcast signals, such as such as SSB can enhance network energy savings. Adaptation of the transmission pattern includes changes to periodicity, time resource locations, and omitting of specific signals/channels e.g., PBCH. The transmission pattern can be adapted semi-statically or dynamically.

SSB patterns (i.e., transmitted SSBs) can be changed (e.g., based on indication from network) semi-statically or dynamically. The gNB transmits the paging configuration in SIB1 which includes the number of PFs, number of POs, default DRX cycle, PF offset, starting PDCCH monitoring occasion number of PO(s) and paging search space.

The gNB also transmits SIB1 including information about periodicity (ssb-PeriodicityServingCell) and transmitted SSBs (ssb-PositionsInBurst). The ssb-PositionsInBurst in SIB1 is used to determine paging occasions together with paging configuration.

One of the issues with SSB adaptation is how the UE determines the paging occasions when the SSB pattern is changed (e.g., for the case where SSBs are not transmitted according to ssb-PositionsInBurst and/or SSB periodicity is changed) from a first SSB pattern (or default SSB pattern) to a second SSB pattern. Various embodiments of the present disclosure provide procedures for a UE to determine paging occasions when the SSB pattern is changed.

The SSB pattern (i.e., transmitted SSBs) can be changed (e.g., based on an indication from the network) semi-statically or dynamically. The gNB signals a RACH configuration which includes a PRACH configuration index (that configures ROs and the PRACH configuration period), SSBs per ROs and Preambles per SSB. SSBs indicated by ssb-PositionsInBurst are mapped to configured ROs.

One of the issues with SSB adaptation is how the UE determines the valid RACH occasions or association between valid RACH occasions and SSBs when the SSB pattern is changed (e.g., for the case where SSBs indicated by ssb-PositionsInBurst are not available in changed SSB pattern) from a first SSB pattern (or default SSB pattern) to a second SSB pattern. Various embodiments of the present disclosure provide procedures for a UE to determine the valid RACH occasions or association between valid RACH occasions and SSBs when the SSB pattern is changed.

The objective of introducing DCP was to avoid a from waking up every DRX cycle for the on-duration. However, under this scheme, the UE monitors the PDCCH during the inactive time, which leads to increased power consumption as the radio of the UE cannot be fully turned off for a long duration. To avoid such situation and to acquire further power saving gain, an additional receiver radio is considered, wherein the additional receiver radio can be used to monitor a particular set of signals with very low power consumption, and the main receiver radio can be turned off or operated with a very lower power for a long duration. For one example, the low power signals can include a low power wake up signal (LP-WUS), e.g., a low power signal for waking up the main receiver and/or for PDCCH monitoring.

In one approach, when the UE receives the low power signal in the configured LP-WUS occasion, the UE starts a timer (“timer X”). The LP-WUS occasion may occur during the on duration and/or before the on duration. An alternate approach is that UE monitors the LP-WUS occasion only outside the on duration, and when UE receives the low power signal in the configured LP-WUS occasion before the on duration, the UE wakes up the main receiver radio and starts the on duration timer. Enhancements are desirable, as the UE is presently unable to know/determine whether to operate as per first or second approach. Various embodiments of the present disclosure provide procedures for the UE to determine whether to operate according to the first or second approach.

Another open issue is that whether to perform radio resource management, radio link management and beam failure detection when, the UE is monitoring the low power signal. Various embodiments of the present disclosure provide procedures for the UE to determine radio resource management, radio link management and beam failure detection when, the UE is monitoring the low power signal.

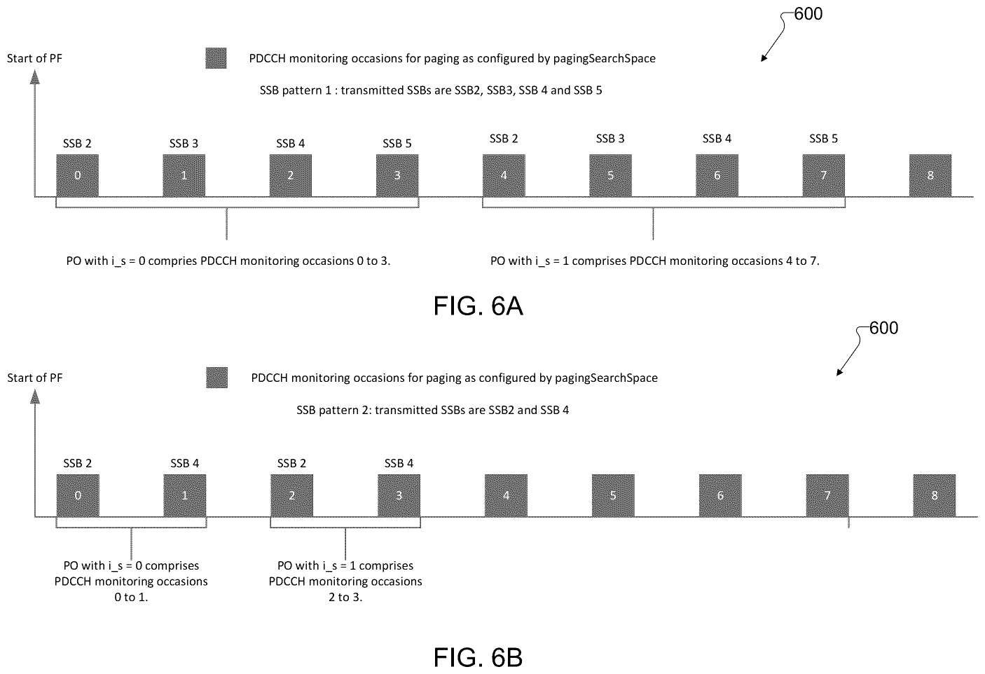

FIG. 5 illustrates an example procedure for determining POs 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for determining POs could be used without departing from the scope of this disclosure.

In the example of FIG. 5, procedure 500 begins at step 510. At step 510, a gNB (such as BS 102 of FIG. 1) transmits SSB(s) based on a first SSB pattern. The SSB pattern may include an SSB periodicity and/or a list of one or more transmitted SSBs. The SSBs may be transmitted in an SSB burst window (the SSB burst window duration can be pre-defined e.g., 5 ms). The SSB burst window may occur periodically, where the period is defined by the SSB periodicity. Time-domain positions of transmitted SSBs can be pre-defined or configured.

At step 520, the gNB transmits system information (e.g., a SIB1) including information about the first SSB pattern. The information includes ssb-PositionsInBurst (which indicates one or more transmitted SSBs) and ssb-PeriodicityServingCell (which indicates the SSB periodicity).

At step 530, the gNB transmits paging configuration in system information (e.g., a SIB1). The paging configuration includes a number of PFs, number of POs, default DRX cycle, PF offset, starting PDCCH monitoring occasion number of PO(s), and paging search space. In some embodiments, the gNB may transmit a PEI configuration in system information (e.g., a SIB1).

At step 540, a UE (such as UE 116 of FIG. 1) UE receives the system information. The UE monitors/receives/measures SSBs based on the first SSB pattern.

In some embodiments, at step 550, the UE determines one or more POs based on SSBs transmitted according to the first SSB pattern and the received paging configuration. The UE monitors the PDCCH addressed to the P-RNTI in the determined PO as follows:
The UE monitors the (is +1)^{th} PO. i_s is determined as explained above herein.
A PO is a set of ‘S*X’ consecutive PDCCH monitoring occasions for paging, where ‘S’ is the number of actual transmitted SSBs determined according to the first SSB pattern, and X is the nrofPDCCH-MonitoringOccasionPerSSB-InPO if configured or is equal to 1 otherwise. PDCCH monitoring occasions for paging are indicated by a paging search space.
The [x*S+K]^{th} PDCCH monitoring occasion for paging in the PO corresponds to the K^{th} transmitted SSB of the first SSB pattern, where x=0, 1, . . . , X−1, K=1, 2, . . . , S.
The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (is +1)^{th} PO is the (is +1)th value of the firstPDCCH-MonitoringOccasionOfPO parameter; otherwise, it is equal to i_s*S*X.

Alternatively, in some embodiments, at step 550 the UE determines a PEI-O based on SSBs transmitted according to the first SSB pattern and the received PEI configuration. The UE monitor PEIs in the determined PEI-O. If PEI is received, UE monitors the determined PO.
A PEI-O is a set of ‘S*X’ consecutive PDCCH MOs for PEI, where ‘S’ is the number of actual transmitted SSBs determined according to first SSB pattern, and X is the nrofPDCCH-MonitoringOccasionPerSSB-InPO if configured or is equal to 1 otherwise. PDCCH MOs for PEI are indicated by pei search space.
The [x*S+K]^{th} PDCCH MO for PEI in the PEI-O corresponds to the K^{th} transmitted SSB of the first SSB pattern, where x=0, 1, . . . , X−1, K=1, 2, . . . , S.
The PDCCH MOs for PEI which do not overlap with UL symbols (determined according to tdd-UL-DL-ConfigurationCommon) are sequentially numbered from zero starting from the first PDCCH MO for PEI in the PEI-O.

At step 560, the gNB decides to transmit SSBs based on a second SSB pattern as follows:
The second SSB pattern may include an SSB periodicity and/or list of one or more transmitted SSBs. The SSBs may be transmitted in an SSB burst window (the SSB burst window duration can be pre-defined e.g., 5 ms). The SSB burst window occurs periodically, where the period is defined by the SSB periodicity. Time-domain positions of transmitted SSBs can be pre-defined or configured.
SSB period of second SSB pattern:
   In some embodiments, the SSB period of the second SSB pattern is the same as the SSB period of first SSB pattern.
   In some embodiments, the SSB period of the second SSB pattern can be different from the SSB period of first SSB pattern. The SSB period of the second SSB pattern can be signaled in system information (e.g., a SIB1). In some embodiments, the SSB period of the second SSB pattern can be signaled in an indication sent by the gNB to switch the SSB pattern
list of one or more SSBs of second SSB pattern:
   In some embodiments, a list is signaled in system information (e.g., a SIB1). A complete list or a delta with respect to a list of one or more SSBs of the first SSB pattern can be signaled.
   Alternatively, in some embodiments the list is indicated in an indication sent by the gNB to switch the SSB pattern. A complete list or a delta with respect to a list of one or more SSBs of the first SSB pattern can be signaled.

At step 570, the gNB sends indication to switch to second SSB pattern. In some embodiments, the indication can be in a SIB1 or short message or LP WUS or PDCCH (common) or MAC CE or RRC message.

At step 580, upon switching to SSB pattern 2, the UE monitors/receives/measures SSBs based on the second SSB pattern.

At step 590, upon switching to SSB pattern 2 (or upon switching to a non-default SSB pattern, SSB pattern 1 can be referred as a default SSB pattern, SSB pattern 2 can be referred to as non-default pattern; in case multiple SSB patterns are supported, SSB pattern 1 can be the default and other patterns can be non-default, or the network can indicate which SSB pattern is the default SSB pattern), or if the current active SSB pattern (i.e., the SSB pattern currently used by network to transmit SSBs) is not a default SSB pattern, the UE monitors for a PEI/PO according to one of options 5-1, 5-2, 5-3, or 5-4 as follows:

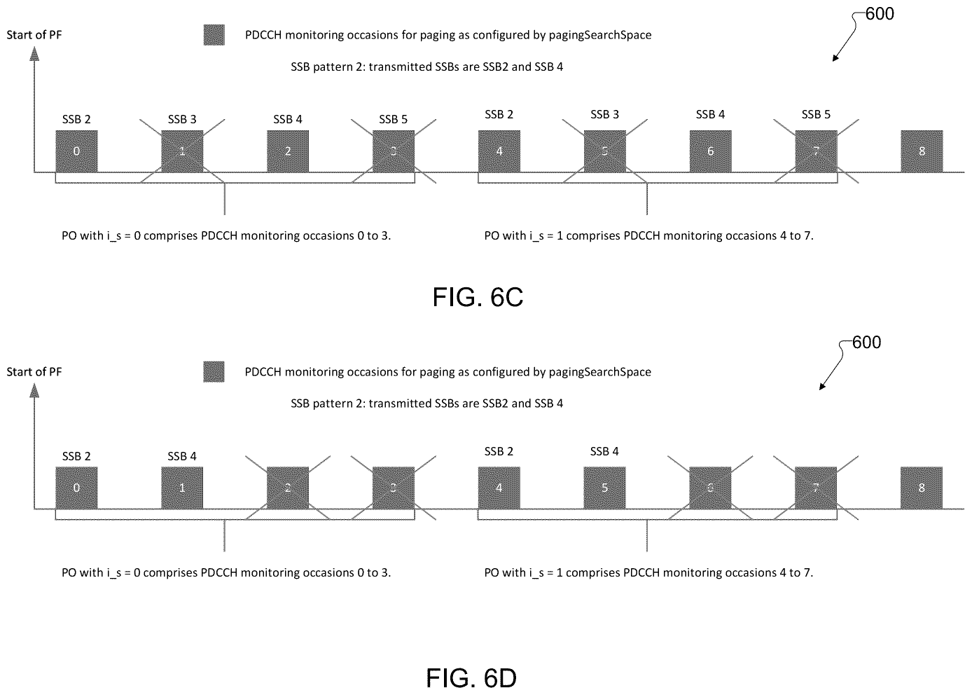

Option 5-1: In some embodiments, the UE determines a PO based on SSBs transmitted according to the second SSB pattern (or the currently active SSB pattern) and receives a paging configuration. The UE monitors for a PDCCH addressed to the P-RNTI in the determined PO.
The UE monitors the (i_s+1)^{th} PO. i_s is determined as explained above herein.
A PO is a set of ‘S*X’ consecutive PDCCH monitoring occasions for paging where ‘S’ is the number of actual transmitted SSBs determined according to the second SSB pattern (or currently active SSB pattern) and X is the nrofPDCCH-MonitoringOccasionPerSSB-InPO if configured or is equal to 1 otherwise. PDCCH monitoring occasions for paging are indicated by the paging search space in the paging configuration.
The [x*S+K]^{th} PDCCH monitoring occasion for paging in the PO corresponds to the K^{th} transmitted SSB of the second SSB pattern (or currently active SSB pattern), where x=0, 1, . . . , X−1, K=1, 2, . . . , S.
The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (is +1)^{th} PO is the (is +1)th value of the firstPDCCH-MonitoringOccasionOfPO parameter; otherwise, it is equal to i_s*S*X.
For example, as shown in FIGS. 6A and 6B, the number of POs per PF in paging configuration is 2, the paging configuration includes pagingSearchSpace, firstPDCCH-MonitoringOccasionOfPO is not configured and nrofPDCCH-MonitoringOccasionPerSSB-InPO is not configured i.e., X equals 1. SSB pattern 1 includes SSB2, SSB3, SSB4 and SSB5. SSB pattern 2 includes SSB2 and SSB4.

FIGS. 6A-6D illustrate an example of PO determination 600 according to embodiments of the present disclosure. The embodiment of PO determination of FIGS. 6A-6D is for illustration only. Different embodiments of PO determination could be used without departing from the scope of this disclosure.

FIG. 6A illustrates an example PO determination by the UE before switching to SSB pattern 2 (i.e., when SSB pattern 1 or a default pattern is used) using the paging configuration received from the network. There are two POs, each PO comprises four PDCCH monitoring occasions for paging, and these four PDCCH monitoring occasions are mapped to SSB 2, SSB3, SSB4 and SSB 5 sequentially. The SSBs transmitted according to the first SSB pattern are SSB 2, SSB3, SSB4 and SSB 5. PO1 starts from PDCCH monitoring occasion #0. PO2 starts from PDCCH monitoring occasion #4.

FIG. 6B illustrates an example PO determination by the UE after switching to SSB pattern 2 using the same paging configuration received from the network. There are two POs, each PO comprises two PDCCH monitoring occasions for paging, these two PDCCH monitoring occasions are mapped to SSB 2 and SSB 4 sequentially. The SSBs transmitted according to the second SSB pattern are SSB 2 and SSB4. PO1 starts from PDCCH monitoring occasion #0. PO2 starts from PDCCH monitoring occasion #2.

FIG. 6C illustrates another example PO determination by the UE after switching to SSB pattern 2 (i.e., when SSB pattern 2 or a non-default pattern is used) using the same paging configuration received from the network. There are two POs, each PO comprises four PDCCH monitoring occasions for paging, these four PDCCH monitoring occasions are mapped to SSB 2, SSB3, SSB4 and SSB 5 sequentially. PO1 starts from PDCCH monitoring occasion #0. PO2 starts from PDCCH monitoring occasion #4. PDCCH monitoring occasions mapped to SSB 3 and SSB 5 are not monitored by the UE and used by the network for paging, as these SSBs are not transmitted in SSB pattern 2.

FIG. 6D illustrates PO determination by the UE after switching to SSB pattern 2 (i.e., when SSB pattern 2 or non-default pattern is used) using the same paging configuration received from network. There are two POs, each PO comprises four PDCCH monitoring occasions for paging, the first two of four PDCCH monitoring occasions in PO are mapped to SSB 2 and SSB4 and remaining two PDCCH monitoring occasions are unused for paging by the UE and the network. PO1 starts from PDCCH monitoring occasions #0. PO2 starts from PDCCH monitoring occasions #4.

Although FIGS. 6A-6D illustrate one example of PO determination 600, various changes may be made to FIGS. 6A-6D. For example, various changes to number of SSBs could be made, etc. according to particular needs.

Option 5-1 (alternate): In some embodiments UE determines a PEI-O based on SSBs transmitted according to second SSB pattern and the received PEI configuration. The UE monitor for PEIs in the determined PEI-O. If a PEI is received, the UE monitors determined PO.
A PEI-O is a set of ‘S*X’ consecutive PDCCH MOs for PEI, where ‘S’ is the number of actual transmitted SSBs determined according to the second SSB pattern (or currently active SSB pattern), and X is the nrofPDCCH-MonitoringOccasionPerSSB-InPO if configured or is equal to 1 otherwise. PDCCH MOs for a PEI are indicated by a PEI search space in the PEI configuration.
The [x*S+K]^{th} PDCCH MO for a PEI in the PEI-O corresponds to the K^{th} transmitted SSB of the second SSB pattern (or currently active SSB pattern), where x=0, 1, . . . , X−1, K=1, 2, . . . , S.
The PDCCH MOs for PEI which do not overlap with UL symbols (determined according to tdd-UL-DL-ConfigurationCommon) are sequentially numbered from zero starting from the first PDCCH MO for PEI in the PEI-O.

Option 5-2: In some embodiments, the UE determines a PO based on SSBs transmitted according to the first SSB pattern (or default SSB pattern) and received paging configuration. The UE monitors for a PDCCH addressed to the P-RNTI in the determined PO. In the determined PO, the UE may not monitor for a PDCCH monitoring occasion associated with an SSB which is not transmitted in the second SSB pattern (or currently active SSB pattern).
The UE monitors the (is +1)^{th} PO. i_s is determined as explained above herein.
A PO is a set of ‘S*X’ consecutive PDCCH monitoring occasions for paging where ‘S’ is the number of actual transmitted SSBs determined according to the first SSB pattern (or default SSB pattern) and X is the nrofPDCCH-MonitoringOccasionPerSSB-InPO if configured or is equal to 1 otherwise. PDCCH monitoring occasions for paging are indicated by a paging search space in the paging configuration.
The [x*S+K]^{th} PDCCH monitoring occasion for paging in the PO corresponds to the K^{th} transmitted SSB of the first SSB pattern (or default SSB pattern), where x=0, 1, . . . , X−1, K=1, 2, . . . , S.
The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (is +1)^{th} PO is the (is +1)th value of the firstPDCCH-MonitoringOccasionOfPO parameter; otherwise, it is equal to i_s*S*X.
For example, as shown in FIGS. 6A and 6C, the number of POs per PF in paging configuration is 2, paging configuration includes pagingSearchSpace, firstPDCCH-MonitoringOccasionOfPO is not configured and nrofPDCCH-MonitoringOccasionPerSSB-InPO is not configured i.e., X equals 1. SSB pattern 1 includes SSB2, SSB3, SSB4 and SSB5. SSB pattern 2 includes SSB2 and SSB4.

Option 5-2 (alternate): In some embodiments the UE determines a PEI-O based on SSBs transmitted according to the first SSB pattern (or default SSB pattern) and the received PEI configuration. The UE monitors for PEIs in the determined PEI-O. If a PEI is received, the UE monitors the determined PO. In the determined PEI-O, the UE may not monitor PDCCH monitoring occasions associated with SSBs which are not transmitted in the second SSB pattern (or current active SSB pattern).
A PEI occasion is a set of ‘S*X’ consecutive PDCCH MOs for PEI, where ‘S’ is the number of actual transmitted SSBs determined according to the first SSB pattern (or default SSB pattern), and X is the nrofPDCCH-MonitoringOccasionPerSSB-InPO if configured or is equal to 1 otherwise. PDCCH MOs for PEI are indicated by a PEI search space in the PEI configuration.
The [x*S+K]^{th} PDCCH MO for PEI in the PEI-O corresponds to the K^{th} transmitted SSB of the first SSB pattern (or default SSB pattern), where x=0, 1, . . . , X−1, K=1, 2, . . . , S.
The PDCCH MOs for PEI which do not overlap with UL symbols (determined according to tdd-UL-DL-ConfigurationCommon) are sequentially numbered from zero starting from the first PDCCH MO for PEI in the PEI-O.

Paging/PEI may not be transmitted by the network using an SSB which is not transmitted in the second SSB pattern (or active SSB pattern).

Option 5-3: In some embodiments, the UE determines a PO based on SSBs transmitted according to first SSB pattern (or default SSB pattern) and received paging configuration. UE monitors PDCCH addressed to P-RNTI in the determined PO.
The UE monitors the (is +1)^{th} PO. is is determined as explained above herein.
A PO is a set of ‘S*X’ consecutive PDCCH monitoring occasions for paging where ‘S’ is the number of actual transmitted SSBs determined according to the first SSB pattern (or default SSB pattern) and X is the nrofPDCCH-MonitoringOccasionPerSSB-InPO if configured or is equal to 1 otherwise. PDCCH monitoring occasions for paging are indicated by a paging search space in the paging configuration.
PDCCH monitoring occasions in the determined PO are then mapped to SSBs transmitted according to the second SSB pattern (or active SSB pattern) sequentially. Remaining PDCCH monitoring occasions (S-L) in the PO are not monitored. The [x*L+K]^{th} PDCCH monitoring occasion for paging in the PO corresponds to the K^{th} transmitted SSB of the second SSB pattern, where x=0, 1, . . . , X−1, K=1, 2, . . . , L where L is number of transmitted SSBs according to SSB pattern 2.
   For example, assume SSBs transmitted according to the first SSB pattern (or default SSB pattern) are SSB1 to SSB 8, and SSBs transmitted according to second SSB pattern (or active SSB pattern) are SSB 9 to SSB 12. There are 8 PDCCH monitoring occasions in the PO. The first four of them are mapped to SSB 9 to SSB 12. The remaining four are not used.
The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (is +1)th PO is the (is +1)th value of the firstPDCCH-MonitoringOccasionOfPO parameter; otherwise, it is equal to i_s*S*X.
For example, as shown in FIGS. 6A and 6D, the number of POs per PF in paging configuration is 2, the paging configuration includes pagingSearchSpace, firstPDCCH-MonitoringOccasionOfPO is not configured and nrofPDCCH-MonitoringOccasionPerSSB-InPO is not configured i.e., X equals 1. SSB pattern 1 includes SSB2, SSB3, SSB4 and SSB5. SSB pattern 2 includes SSB2 and SSB4.

Option 5-4: In some embodiments, the UE determines the PO based on SSBs transmitted according to the second SSB pattern (or active SSB pattern) and the second paging configuration received from the network. The UE monitors for paging in the determined PO. The second paging configuration may include a starting PDCCH monitoring occasion number of PO(s) and/or paging search space and/or other paging configuration. Each of these first and second paging configurations is optimized for the first (or default SSB pattern) and second SSB pattern (or non-default SSB pattern) respectively.

Option 5-4 (alternate): In some embodiments, the UE determines a PEI based on SSBs transmitted according to the second SSB pattern (or active SSB pattern) and the second PEI configuration. The UE monitors for a PEI in the determined PEI-O. The second PEI configuration may include a starting PDCCH monitoring occasion number of PEI-O(s) and/or a PEI search space and/or PEI paging configuration.

In some embodiments, the second paging/PEI configuration can be explicitly signaled or derived from the first configuration (e.g., based on scaling factor). For example, the number of PFs in the paging configuration for the second SSB pattern can be K times the number of PFs in the paging configuration for the first SSB pattern (or default SSB pattern). The number of POs in the paging configuration for the second SSB pattern can be P times the number of POs in the paging configuration for the first SSB pattern (or default SSB pattern). The DRX cycle length in the paging configuration for the second SSB pattern can be Q times the DRX cycle length in the paging configuration for the first SSB pattern (or default SSB pattern). K/Q/P can be the same or different and can be signaled. K/Q/P can be equal to the number of SSBs transmitted in the second SSB pattern/the number of SSBs transmitted in the first SSB pattern (or default SSB pattern).

Although FIG. 5 illustrates one example procedure for determining POs 500, various changes may be made to FIG. 5. For example, while shown as a series of steps, various steps in FIG. 5 could overlap, occur in parallel, occur in a different order, occur any number of times, be omitted, or replaced by other steps.

In some embodiments, the network may transmit a complete SSB in some SSB periods and a partial SSB in some SSB periods. A complete SSB means PSS/SSS/PBCH is transmitted. A partial SSB means at least one of PSS or SSS or PBCH is not transmitted. The signals (PSS and/or SSS and/or PBCH) which are not transmitted in the partial SSB can be pre-defined or signaled by the network e.g., in system information (e.g., a MIB or SIB) or an RRC message.

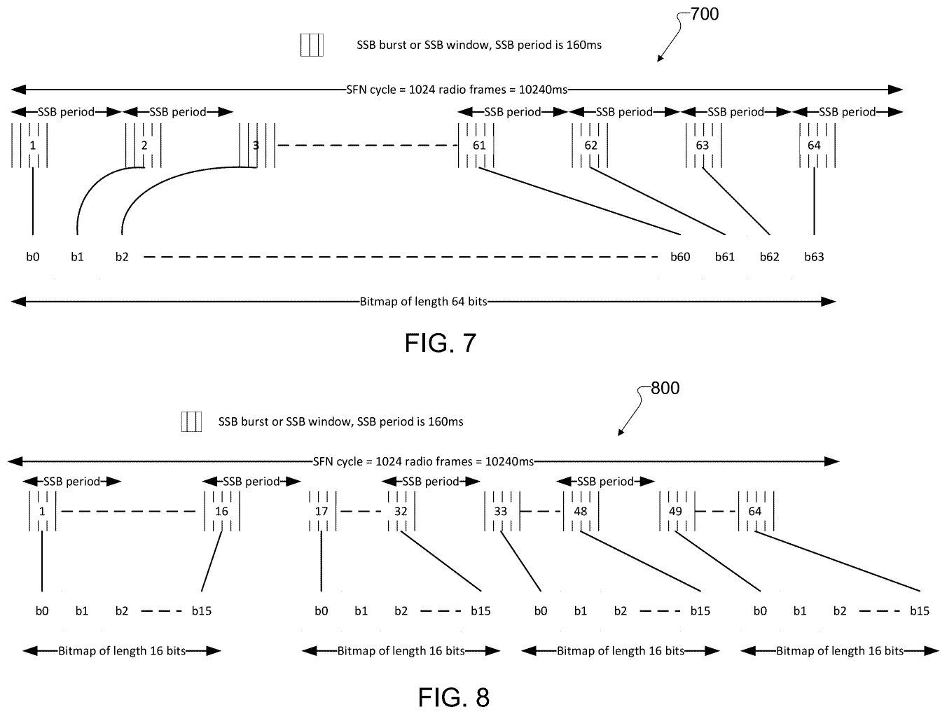

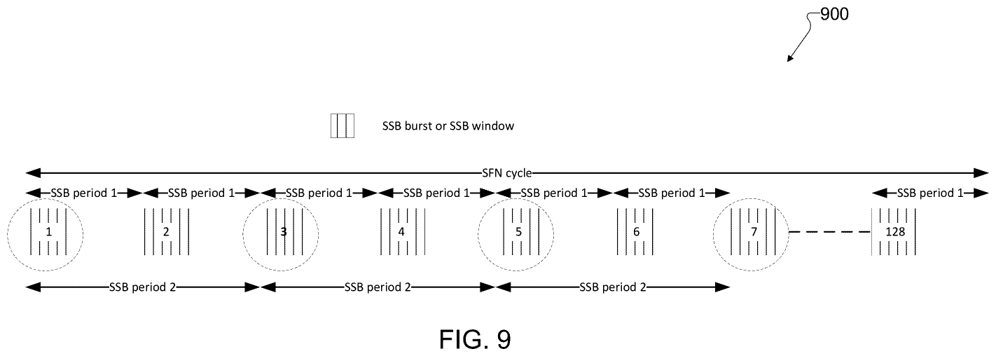

In some embodiments, in order for the UE to know whether a complete SSB or partial SSB is transmitted in which SSB period, the network can signal a bitmap of length N. N can be fixed or configurable. The UE receives the bitmap in system information (e.g., a MIB or SIB) or an RRC message from the gNB. The UE also receives the SSB periodicity info from the gNB. Based on the bitmap, the UE determines in which SSB bursts/SSB windows/SSB periods SSBs transmitted are partial or complete as follows:
Each bit in the bitmap corresponds to one of the N consecutive SSB bursts/SSB windows/SSB periods. Bits in the bitmap can be mapped to N consecutive SSB bursts/SSB windows/SSB periods from least significant bit (lsb) to most significant bit (msb) or msb to lsb. A bit corresponding to an SSB burst/SSB window/SSB period indicates whether SSBs transmitted in that SSB burst/SSB window/SSB period are complete or partial. A bit set to 0 may indicate partial SSB transmission in the SSB burst/SSB window/SSB period, and a bit set to 1 may indicate complete SSB transmission in the SSB burst/SSB window/SSB period. Alternately, bit set to 1 may indicate a partial SSB transmission in the SSB burst/SSB window/SSB period, and a bit set to 0 may indicate a complete SSB transmission in the SSB burst/SSB window/SSB period.
There can be several SSB bursts/SSB windows/SSB periods in an SFN cycle. The size of the bitmap can be equal to the total number of SSB bursts/SSB windows/SSB periods in an SFN cycle or it can be less than the total number of SSB bursts/SSB windows/SSB periods in an SFN cycle. Same bitmap is applied to each set of N consecutive SSB bursts/SSB windows/SSB periods starting from beginning of SFN cycle. The bitmap is applied to first set of N consecutive SSB bursts/SSB windows/SSB periods from the beginning of the SFN cycle. The bitmap is then applied to a second set (if any) of N consecutive SSB bursts/SSB windows/SSB periods from the end of the first set in the SFN cycle. The bitmap is then applied to third set (if any) of N consecutive SSB bursts/SSB windows/SSB periods from the end of the second set in the SFN cycle. In case a total number of SSB bursts/SSB windows/SSB periods in an SFN cycle is not a multiple of N, the bitmap is partially applied at the end of the SFN cycle.
   For example, assuming the SFN cycle is 1024 radio frames, each radio frame is 10 ms, and the SSB period is 160m, the total number of SSB bursts/SSB windows/SSB periods is 1024* 10/160=64.
   The size of the bitmap can be equal to the total number of SSB bursts/SSB windows/SSB periods in an SFN cycle i.e., 64 bits. Bits b0 to b63 (lsb to msb or msb to lsb) in the bit map are mapped sequentially to 64 SSB bursts/SSB windows/SSB periods starting from first SSB burst/SSB window/SSB period in SFN cycle as shown in FIG. 7.
   The size of bitmap can be smaller than total number of SSB bursts/SSB windows/SSB periods in an SFN cycle to reduce the signaling overhead. For example, N can be 16 bits. Bits b0 to b15 (lsb to msb or msb to lsb) in bit map are mapped sequentially (as shown in FIG. 8) to
      The first set of 16 SSB bursts/SSB windows/SSB periods in SFN cycle i.e., 1^{st} to 16 th SSB bursts/SSB windows/SSB periods.
      The second set of 16 SSB bursts/SSB windows/SSB periods in SFN cycle i.e., 17^{th} to 32^{nd} SSB bursts/SSB windows/SSB periods.
      The third set of 16 SSB bursts/SSB windows/SSB periods in SFN cycle i.e., 33rd to 48th SSB bursts/SSB windows/SSB periods.
      The fourth set of 16 SSB bursts/SSB windows/SSB periods in SFN cycle i.e., 49^{th} to 64^{th} SSB bursts/SSB windows/SSB periods.

The UE then receives/measures the partial SSB or complete SSB in the corresponding SSB bursts/SSB windows/SSB periods.

FIG. 7 illustrates an example bitmap 700 according to embodiments of the present disclosure. The embodiment of a bitmap of FIG. 7 is for illustration only. Different embodiments of a bitmap could be used without departing from the scope of this disclosure.

Although FIG. 7 illustrates one example bitmap 700, various changes may be made to FIG. 7. For example, various changes to bitmap length, etc. could be made according to particular needs.

FIG. 8 illustrates another example bitmap 800 according to embodiments of the present disclosure. The embodiment of a bitmap of FIG. 8 is for illustration only. Different embodiments of a bitmap could be used without departing from the scope of this disclosure.

Although FIG. 8 illustrates one example bitmap 800, various changes may be made to FIG. 8. For example, various changes to bitmap length, etc. could be made according to particular needs.

In some embodiments, the network may transmit a complete SSB in some SSB periods and a partial SSB in some SSB periods. A complete SSB means PSS/SSS/PBCH is transmitted. A partial SSB means at least one of PSS or SSS or PBCH is not transmitted. The signals (PSS and/or SSS and/or PBCH) which are not transmitted in the partial SSB can be pre-defined or signaled by the network.

In some embodiments, in order for the UE to know whether a complete SSB or partial SSB is transmitted in which SSB period, the network can signal a first SSB periodicity and a second SSB periodicity. The First SSB periodicity indicates the periodicity at which an SSB burst/window occurs in a SFN cycle.

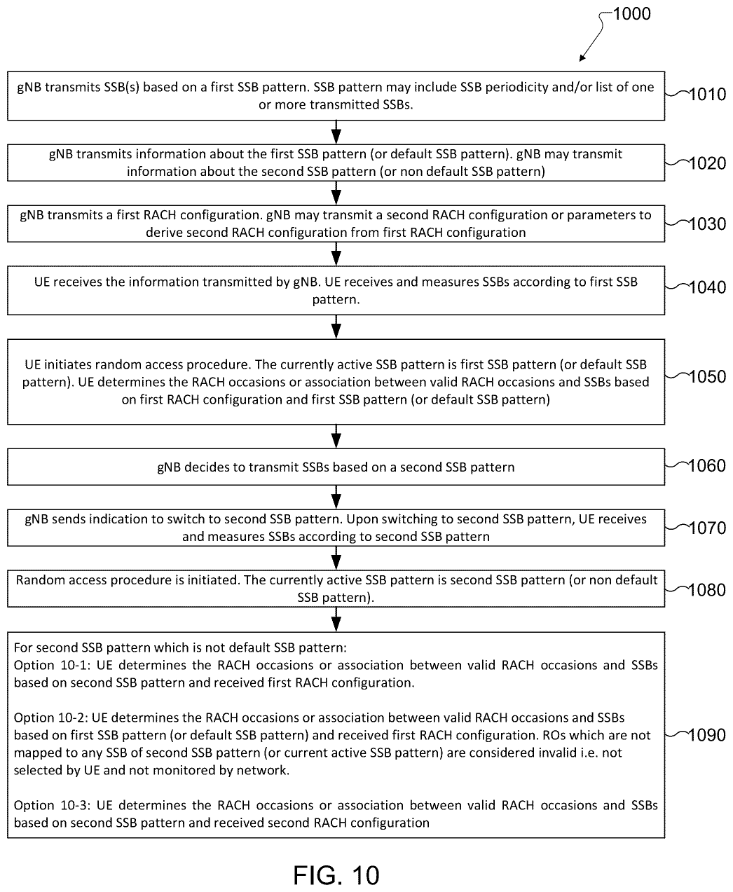

In some embodiments, a second SSB periodicity indicates the periodicity at which an SSB burst/window with a partial SSB occurs in an SFN cycle. The SSB burst/window based on the first SSB periodicity, which is not the same as the SSB burst/window based on the second periodicity, is an SSB burst/window with a complete SSB.
For example, assuming that the first SSB periodicity is 80 ms and second SSB periodicity is 160 ms, the SSB burst/window which occurs at every 160 ms is the SSB burst/window with the partial SSB. As shown in FIG. 9, SSB burst/windows 1, 3, 5, 7 and so on are SSB bursts/windows with a partial SSB. Other SSB bursts/windows are SSB bursts/windows with a complete SSB.

FIG. 9 illustrates an example SFN cycle 900 according to embodiments of the present disclosure. The embodiment of an SFN cycle of FIG. 9 is for illustration only. Different embodiments of an SFN cycle could be used without departing from the scope of this disclosure.

Although FIG. 9 illustrates one example SFN cycle 900, various changes may be made to FIG. 9. For example, various changes to the SSB periods could be made, etc. according to particular needs.

In some embodiments, the second SSB periodicity indicates the periodicity at which an SSB burst/window with a complete SSB occurs in a SFN cycle. An SSB burst/window based on the first SSB periodicity, which is not the same as the SSB burst/window based on the second periodicity, is an SSB burst/window with a partial SSB.

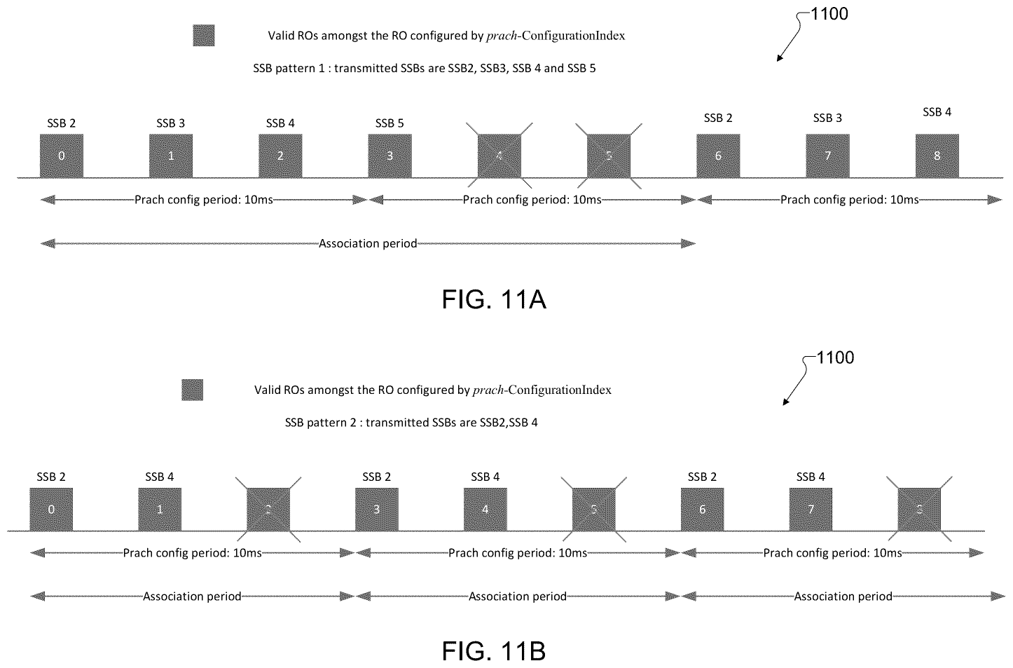

FIG. 10 illustrates an example procedure to determine valid RACH occasions 1000 according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure to determine valid RACH occasions could be used without departing from the scope of this disclosure.

In the example of FIG. 10, procedure 1000 begins at step 1010. At step 1010, a gNB (such as BS 102 of FIG. 1) transmits SSB(s) based on a first SSB pattern (or default SSB pattern). The SSB pattern may include an SSB periodicity and/or list of one or more transmitted SSBs. The SSBs may be transmitted in an SSB burst window (the SSB burst window duration can be pre-defined e.g., 5 ms). The SSB burst window occurs periodically where the period is defined by the SSB periodicity. Time-domain positions of transmitted SSBs can be pre-defined or configured.

At step 1020, the gNB transmits information about the first SSB pattern (or default SSB pattern). The information can be included in system information (e.g., a SIB) or in an RRC message. The information includes ssb-PositionsInBurst (which indicates one or more transmitted SSBs) and ssb-PeriodicityServingCell (which indicates SSB periodicity).

At step 1030, the gNB transmits a first RACH configuration. The information can be included in system information (e.g., a SIB) or in an RRC message. The RACH configuration includes a PRACH configuration index (which configures ROs and the PRACH configuration period), SSBs per ROs, and Preambles per SSB. In some embodiments, the gNB may transmit a second RACH configuration or parameters to derive a second RACH configuration from the first RACH configuration. Each of these first and second RA configurations may be optimized for the first (or default SSB pattern) and second SSB pattern (or non-default SSB pattern) respectively.

At step 1040, a UE (such as UE 116 of FIG. 1) receives the information transmitted by gNB.

At step 1050, the UE initiates a random access procedure based on one of the triggers explained herein. The currently active SSB pattern is the first SSB pattern (or default SSB pattern). The UE determines the RACH occasions or association between valid RACH occasions and SSBs based on the first RACH configuration and first SSB pattern (or default SSB pattern) as follows:
The First RACH configuration received in step 1030 includes prach-ConfigurationIndex. prach-ConfigurationIndex indicates the PRACH occasions for the transmission of the Random Access Preamble. The number of PRACH occasions in the PRACH configuration period is pre-defined for each PRACH configuration index. The PRACH configuration period for each PRACH configuration index is also pre-defined. A pre-defined PRACH configuration table lists the number of configurations, wherein each configuration indicates the number of PRACH occasions in the PRACH configuration period, the PRACH configuration period, and the location of PRACH occasions in the PRACH configuration period. A PRACH configuration index is an index to an entry in this PRACH configuration table.
The First RACH configuration received in step 1030 includes ssb-perRACH-OccasionAndCB-PreamblesPerSSB. ssb-perRACH-OccasionAndCB-PreamblesPerSSB indicates CB-PreamblesPerSSB (R) and ssb-perRACH-Occasion (N).
Based on ssb-perRA CH-Occasion and SSBs transmitted according to the first SSB pattern (or default SSB pattern) in the cell, valid PRACH occasions (for paired spectrum or a supplementary uplink band all PRACH occasions are valid) amongst the PRACH occasions configured by prach-ConfigurationIndex are mapped to SSBs transmitted according to the first SSB pattern (or default SSB pattern) in the following order:
   First, in increasing order of preamble indexes within a single PRACH occasion.
   Second, in increasing order of frequency resource indexes for frequency multiplexed PRACH occasions.
   Third, in increasing order of time resource indexes for time multiplexed PRACH occasions within a PRACH slot.
   Fourth, in increasing order of indexes for PRACH slots.
An association period, starting from frame 0, for mapping SSBs indexes to PRACH occasions is the smallest value in the set determined by the PRACH configuration period according to Table 1 such that transmitted SSBs according to first SSB pattern (or default SSB pattern) are mapped at least once to the PRACH occasions within the association period. If after an integer number of SSBs to PRACH occasions mapping cycles within the association period there is a set of PRACH occasions or PRACH preambles that are not mapped to SSBs, no SSBs are mapped to the set of PRACH occasions or PRACH preambles.
Preambles for SSBs of the first SSB pattern are determined as follows:
   If N<1, one SSB is mapped to 1/N consecutive valid PRACH occasions and R contention based preambles with consecutive indexes associated with the SSB per valid PRACH occasion start from preamble index 0. If N≥1, R contention based preambles with consecutive indexes associated with SSB n, 0≤n≤N−1, per valid PRACH occasion start from preamble index n·N_{preamble}^{total}/N, where N_{preamble}^{total} is provided by totalNumberOfRA-Preambles and is an integer multiple of N. totalNumberOfRA-Preambles is signaled by the gNB in a RACH configuration.
The UE selects an SSB from SSBs transmitted in the first SSB pattern. The UE then selects a PRACH occasion associated with that SSB based on the determined SSBs to PRACH occasions mapping. The UE selects a preamble associated with that SSB based on the determined SSBs to preambles mapping. The UE transmits the selected preamble in the selected PRACH occasion.

At step 1060, the gNB decides to transmit SSBs based on a second SSB pattern.
The second SSB pattern may include SSB periodicity and/or a list of one or more transmitted SSBs. The SSBs may be transmitted in an SSB burst window (the SSB burst window duration can be pre-defined e.g., 5 ms). The SSB burst window occurs periodically, where the period is defined by SSB periodicity. Time-domain positions of transmitted SSBs can be pre-defined or configured.
SSB period of the second SSB pattern:
   In some embodiments, the SSB period of the second SSB pattern is the same as the SSB period of the first SSB pattern.
   Alternatively, in some embodiments the SSB period of the second SSB pattern can be different from the SSB period of the first SSB pattern. The SSB period of the second SSB pattern can be signaled in system information (e.g., SIB1). The SSB period of the second SSB pattern can be signaled in an indication sent by the gNB to switch the SSB pattern.
list of one or more SSBs of the second SSB pattern:
   In some embodiments, a list is signaled in system information (e.g., a SIB1). A complete list or a delta with respect to a list of one or more SSBs of the first SSB pattern can be signaled.
   Alternatively, in some embodiments, the list is indicated in indication sent by the gNB to switch the SSB pattern. A complete list or a delta with respect to a list of one or more SSBs of the first SSB pattern can be signaled.

At step 1070, the gNB sends an indication to switch to the second SSB pattern. In some embodiments, the indication can be in a SIB1 or short message or LP WUS or PDCCH (common) or MAC CE or RRC message. The UE receives and measures SSBs according to the second SSB pattern (or a non-default SSB pattern, the first SSB pattern can be referred to as a default SSB pattern, the second SSB pattern can be referred to as a non-default pattern; in case multiple SSB patterns are supported, the first SSB pattern can be the default and other patterns can be non-default, or the network can indicate which SSB pattern is the default SSB pattern).

At step 1080, a random access procedure is initiated based on one of the triggers explained herein. The currently active SSB pattern is second SSB pattern.

At step 1090, the second SSB pattern is a non-default SSB pattern. The UE determines the RACH occasions or association between valid RACH occasions and SSBs according to one of options 10-1, 10-2, or 10-3 as follows:

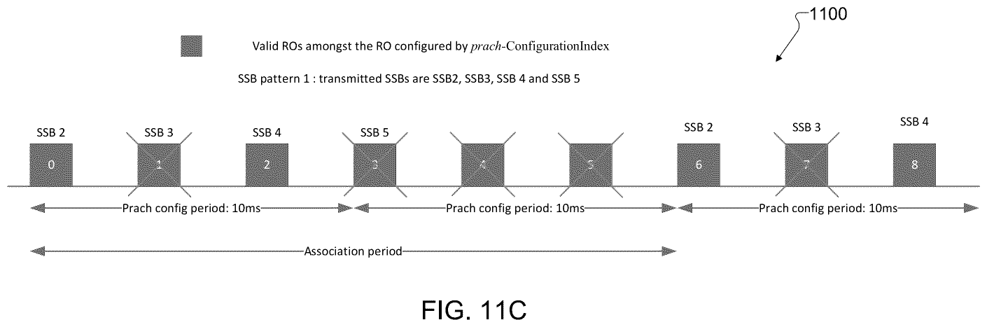

Option 10-1: In some embodiments, the UE determines the RACH occasions or association between valid RACH occasions and SSBs based on the second SSB pattern and received first RACH configuration, similar as shown in FIGS. 11A and 11B.
The first RACH configuration received in step 1030 includes prach-ConfigurationIndex. prach-ConfigurationIndex indicates the PRACH occasions for the transmission of the Random Access Preamble. The number of PRACH occasions in the PRACH configuration period is pre-defined for each PRACH configuration index. The PRACH configuration period for each PRACH configuration index is also pre-defined. A pre-defined PRACH configuration table lists a number of configurations, wherein each configuration indicates a number of PRACH occasions in the PRACH configuration period, the PRACH configuration period, and the location of the PRACH occasions in the PRACH configuration period. The PRACH configuration index is an index to an entry in this PRACH configuration table.
The first RACH configuration received in step 1030 includes ssb-perRACH-OccasionAndCB-PreamblesPerSSB. ssb-perRACH-OccasionAndCB-PreamblesPerSSB indicates CB-PreamblesPerSSB (R) and ssb-perRACH-Occasion (N).
Based on ssb-perRACH-Occasion and the SSBs transmitted according to the second SSB pattern in the cell, valid PRACH occasions (for paired spectrum or supplementary uplink band all PRACH occasions are valid) amongst the PRACH occasions configured by prach-ConfigurationIndex are mapped to SSBs of the second SSB pattern in the following order:
   First, in increasing order of preamble indexes within a single PRACH occasion.
   Second, in increasing order of frequency resource indexes for frequency. multiplexed PRACH occasions.
   Third, in increasing order of time resource indexes for time multiplexed PRACH occasions within a PRACH slot.
   Fourth, in increasing order of indexes for PRACH slots.
An association period, starting from frame 0, for mapping the SSBs indexes to PRACH occasions is the smallest value in the set determined by the PRACH configuration period according to Table 1 such that transmitted SSBs according to second SSB pattern are mapped at least once to the PRACH occasions within the association period. If after an integer number of SSBs to PRACH occasions mapping cycles within the association period there is a set of PRACH occasions or PRACH preambles that are not mapped to SSBs, no SSBs are mapped to the set of PRACH occasions or PRACH preambles.
Preambles for SSBs of second SSB pattern are determined as follows:
   If N<1, one SSB is mapped to 1/N consecutive valid PRACH occasions and R contention based preambles with consecutive indexes associated with the SSB per valid PRACH occasion start from preamble index 0. If N≥1, R contention based preambles with consecutive indexes associated with SSB n, 0≤n≤N−1, per valid PRACH occasion start from preamble index n·N_{preamble}^{total}/N where N_{preamble}^{total} is provided by totalNumberOfRA-Preambles and is an integer multiple of N. totalNumberOfRA-Preambles is signaled by gNB in RACH configuration.
The UE selects an SSB from SSBs transmitted in the second SSB pattern. The UE then selects a PRACH occasion associated with that SSB based on the determined SSB to PRACH occasions mapping. The UE selects a preamble associated with that SSB based on the determined SSB to preambles mapping. The UE transmits the selected preamble in the selected PRACH occasion.

FIGS. 11A-11C illustrate an example PRACH occasion to SSB mapping determination 1100 according to embodiments of the present disclosure. The embodiment of PRACH occasion to SSB mapping determination of FIG. FIGS. 11A-11C is for illustration only. Different embodiments of a PRACH occasion to SSB mapping determination could be used without departing from the scope of this disclosure.

FIG. 11A illustrates a PRACH occasion to SSB mapping determination by the UE before switching to SSB pattern 2 using the first RACH configuration received from the network. The valid PRACH occasions amongst the PRACH occasions configured by prach-ConfigurationIndex are mapped to SSB 2, SSB3, SSB4 and SSB 5 sequentially. ssb-perRACH-Occasion (N) is one in this example. The PRACH configuration period is 10 ms and includes 3 PRACH occasions. The association period is 20 ms as two PRACH configuration periods are needed to map all SSBs of the first SSB pattern to the PRACH occasions. PRACH occasions 4 and 5 in the association period are unused or not mapped to any SSBs.

FIG. 11B illustrates a PRACH occasion to SSB mapping determination by the UE after switching to SSB pattern 2 using the same RA configuration received from the network. The valid PRACH occasions amongst the PRACH occasions configured by prach-ConfigurationIndex are mapped to SSB 2 and SSB 4 sequentially. The PRACH configuration period is 10 ms and includes 3 PRACH occasions. The association period is 10 ms as one PRACH configuration period is needed to map all SSBs of second SSB pattern to PRACH occasions. The last PRACH occasion in each PRACH configuration period/association period is unused or not mapped to any SSBs.

FIG. 11C illustrates another PRACH occasion to SSB mapping determination by the UE after switching to SSB pattern 2 using the same RA configuration received from the network. ssb-perRACH-Occasion (N) is one in this example. The valid PRACH occasions amongst the PRACH occasions configured by prach-ConfigurationIndex are mapped to SSB 2, SSB3, SSB4 and SSB 5 sequentially. The PRACH configuration period is 10 ms and includes 3 PRACH occasions. The Association period is 20 ms as two PRACH configuration periods are needed to map all of the SSBs of the first SSB pattern to PRACH occasions. PRACH occasions 4 and 5 in the association period are unused or not mapped to any SSBs. PRACH occasions mapped to SSB3 and SSB5 are also considered invalid (i.e., not selected by UE) and not monitored by the network.

Although FIGS. 11A-11C illustrate one example PRACH occasion to SSB mapping determination 1100, various changes may be made to FIGS. 11A-11C. For example, various changes to the number of SSBs, the association periods, etc. according to particular needs.

Option 10-2: In some embodiments, the UE determines the RACH occasions or association between valid RACH occasions and SSBs based on first SSB pattern (or default SSB pattern) and received RACH configuration similar as shown in FIGS. 11A and 11C.
The RACH configuration received in step 1030 includes prach-ConfigurationIndex. prach-ConfigurationIndex indicates the PRACH occasions for the transmission of the Random Access Preamble. The number of PRACH occasions in the PRACH configuration period is pre-defined for each PRACH configuration index. The PRACH configuration period for each PRACH configuration index is also pre-defined. A pre-defined PRACH configuration table lists a number of configurations, wherein each configuration indicates a number of PRACH occasions in the PRACH configuration period, the PRACH configuration period, and the location of PRACH occasions in PRACH configuration period. A PRACH configuration index is an index to an entry in this PRACH configuration table.
The RACH configuration received in step 1030 includes ssb-perRACH-OccasionAndCB-PreamblesPerSSB. ssb-perRACH-OccasionAndCB-PreamblesPerSSB indicates CB-PreamblesPerSSB (R) and ssb-perRACH-Occasion (N).
Based on ssb-perRACH-Occasion and the SSBs transmitted according to the first SSB pattern in the cell, valid PRACH occasions (for paired spectrum or supplementary uplink band all PRACH occasions are valid) amongst the PRACH occasions configured by prach-ConfigurationIndex are mapped to SSBs of the first SSB pattern. PRACH occasions are mapped to SSBs of the first SSB pattern over association period in following order:
   First, in increasing order of preamble indexes within a single PRACH occasion.
   Second, in increasing order of frequency resource indexes for frequency multiplexed PRACH occasions.
   Third, in increasing order of time resource indexes for time multiplexed PRACH occasions within a PRACH slot.
   Fourth, in increasing order of indexes for PRACH slots.
An association period, starting from frame 0, for mapping SSB indexes to PRACH occasions is the smallest value in the set determined by the PRACH configuration period according to Table 1 such that transmitted SSBs according to first SSB pattern are mapped at least once to the PRACH occasions within the association period. If after an integer number of SSBs to PRACH occasions mapping cycles within the association period there is a set of PRACH occasions or PRACH preambles that are not mapped to SSBs, no SSBs are mapped to the set of PRACH occasions or PRACH preambles.
Preambles for SSBs of first SSB pattern are determined as follows:
   If N<1, one SSB is mapped to 1/N consecutive valid PRACH occasions and R contention based preambles with consecutive indexes associated with the SSB per valid PRACH occasion start from preamble index 0. If N≥1, R contention based preambles with consecutive indexes associated with SSB n, 0≤n≤N−1, per valid PRACH occasion start from preamble index n·N_{preamble}^{total}/N where N_{preamble}^{total} is provided by totalNumberOfRA-Preambles and is an integer multiple of N. totalNumberOfRA-Preambles is signaled by the gNB in a RACH configuration.
In some embodiments, the UE select an SSB from the SSBs transmitted in the second SSB pattern. Alternatively, in some embodiments, the UE may select an SSB from SSBs commonly present in the first and second SSB pattern. The UE then selects a PRACH occasion associated with that SSB based on the determined SSB to PRACH occasions mapping. The UE selects a preamble associated with that SSB based on the determined SSB to preamble mapping. The UE transmits the selected preamble in the selected PRACH occasion.

Option 10-3: In some embodiments, the UE determines the RACH occasions or association between valid RACH occasions and SSBs based on the second SSB pattern (or currently active SSB pattern) and the received second RACH configuration. Each of these first and second RA configurations is optimized for the first (or default SSB pattern) and second SSB pattern (or non-default SSB pattern) respectively.
The Second RACH configuration received in step 1030 includes prach-ConfigurationIndex. prach-ConfigurationIndex indicates the PRACH occasions for the transmission of the Random Access Preamble. The number of PRACH occasions in the PRACH configuration period is pre-defined for each PRACH configuration index. The PRACH configuration period for each PRACH configuration index is also pre-defined. A pre-defined PRACH configuration table lists a number of configurations, wherein each configuration indicates a number of PRACH occasions in the PRACH configuration period, the PRACH configuration period, and the location of PRACH occasions in the PRACH configuration period. A PRACH configuration index is an index to an entry in this PRACH configuration table.
The Second RACH configuration received in step 1030 includes ssb-perRACH-OccasionAndCB-PreamblesPerSSB. ssb-perRACH-OccasionAndCB-PreamblesPerSSB indicates CB-PreamblesPerSSB (R) and ssb-perRACH-Occasion (N).
Based on ssb-perRACH-Occasion and SSBs transmitted according to the second SSB pattern in the cell, valid PRACH occasions (for paired spectrum or supplementary uplink band all PRACH occasions are valid) amongst the PRACH occasions configured by prach-ConfigurationIndex of the second RACH configuration are mapped to SSBs of the second SSB pattern in the following order:
   First, in increasing order of preamble indexes within a single PRACH occasion.
   Second, in increasing order of frequency resource indexes for frequency multiplexed PRACH occasions.
   Third, in increasing order of time resource indexes for time multiplexed PRACH occasions within a PRACH slot.
   Fourth, in increasing order of indexes for PRACH slots
An association period, starting from frame 0, for mapping SSBs indexes to PRACH occasions is the smallest value in the set determined by the PRACH configuration period according to Table 1 such that transmitted SSBs according to second SSB pattern are mapped at least once to the PRACH occasions within the association period. If after an integer number of SSBs to PRACH occasions mapping cycles within the association period there is a set of PRACH occasions or PRACH preambles that are not mapped to SSBs, no SSBs are mapped to the set of PRACH occasions or PRACH preambles.
Preambles for SSBs of the second SSB pattern are determined as follows:
   If N<1, one SSB is mapped to 1/N consecutive valid PRACH occasions and R contention based preambles with consecutive indexes associated with the SSB per valid PRACH occasion start from preamble index 0. If N≥1, R contention based preambles with consecutive indexes associated with SSB n, 0≤n≤N−1, per valid PRACH occasion start from preamble index n·N_{preamble}^{total}/N where N_{preamble}^{total} is provided by totalNumberOfRA-Preambles and is an integer multiple of N. totalNumberOfRA-Preambles is signaled by gNB in RACH configuration.
The UE selects an SSB from SSBs transmitted in the second SSB pattern. The UE then selects an RO and preamble associated with that SSB. The UE transmits the selected preamble in the selected RO.

Although FIG. 10 illustrates one example procedure to determine valid RACH occasions 1000, various changes may be made to FIG. 10. For example, while shown as a series of steps, various steps in FIG. 10 could overlap, occur in parallel, occur in a different order, occur any number of times, be omitted, or replaced by other steps.

In some embodiments, a separate PRACH configuration index and/or SSBs per ROs and/or Preambles per SSB′ for each SSB pattern can be signaled by the gNB. The UE may apply the configuration corresponding to the active SSB pattern to determine the PRACH occasion to SSB mapping and preamble to SSB mapping.

In some embodiments, a scaling factor can be used to determine the SSBs per ROs to be applied for an SSB pattern. The SSBs per ROs is explicitly signaled for a default SSB pattern (e.g., SSB pattern 1).
In some embodiments, a scaling factor K can be signaled for a non-default SSB pattern (e.g., SSB pattern 2).
   The SSBs per RO for non the default SSB pattern is equal to K*SSBs per ROs for the default SSB pattern.
Alternatively, in some embodiment the scaling factor K=number of SSBs transmitted for the non-default SSB pattern/number of SSBs transmitted for the default SSB pattern.
   The SSBs per RO for the non-default SSB pattern is equal to K*SSBs per ROs for the default SSB pattern.
Alternatively, in some embodiments the scaling factor K=number of SSBs transmitted for the default SSB pattern/number of SSBs transmitted for the non-default SSB pattern
   The SSBs per RO for non-default SSB pattern is equal to (1/K)*SSBs per ROs for the default SSB pattern.

In some embodiments, a scaling factor can be used to determine preambles per SSBs to be applied for an SSB pattern. The preambles per SSBs is explicitly signaled for a default SSB pattern (e.g., SSB pattern 1).
In some embodiments, a scaling factor K can be signaled for a non-default SSB pattern (e.g., SSB pattern 2).
   The preambles per SSBs for the non-default SSB pattern is equal to K*preambles per SSBs for default SSB pattern.
Alternatively, in some embodiments scaling factor K=number of SSBs transmitted for the non-default SSB pattern/number of SSBs transmitted for the default SSB pattern.
   The preambles per SSBs for the non-default SSB pattern is equal to (1/K)*preambles per SSBs for the default SSB pattern.
   Alternatively, in some embodiments the scaling factor K=number of SSBs transmitted for the default SSB pattern/number of SSBs transmitted for the non-default SSB pattern.
   The SSBs per RO for the non-default SSB pattern is equal to (K)*preambles per SSBs for the default SSB pattern.

In some embodiments, a scaling factor can be used to determine the PRACH configuration period to be applied for an SSB pattern. The PRACH configuration period is explicitly signaled for a default SSB pattern (say SSB pattern 1) using a PRACH configuration index.
In some embodiments, a scaling factor K can be signaled for a non-default SSB pattern (e.g., SSB pattern 2).
   The PRACH configuration period for the non-default SSB pattern is equal to K*PRACH configuration period for the default SSB pattern.
Alternatively, in some embodiments the scaling factor K=number of SSBs transmitted for the non-default SSB pattern/number of SSBs transmitted for the default SSB pattern.
   The PRACH configuration period for the non-default SSB pattern is equal to (K)*PRACH configuration period for the default SSB pattern.
Alternatively, in some embodiments the scaling factor K=number of SSBs transmitted for the default SSB pattern/number of SSBs transmitted for the non-default SSB pattern
   The PRACH configuration period for the non-default SSB pattern is equal to (1/K)*PRACH configuration period for the default SSB pattern.

In some embodiments, the PRACH configuration period to be applied for a non-default SSB pattern can be pre-defined.

In some embodiments, if the active SSB pattern is not the default SSB pattern:
One or more PRACH occasions amongst the PRACH occasions signaled by the RACH configuration (PRACH configuration index) per PRACH configuration period, can be considered as invalid.
   Invalid PRACH occasions can be indicated/signaled by a bitmap, a bit can be set to I/O to indicate a valid/invalid PRACH occasion, PRACH occasions in the PRACH configuration period can be mapped to bits in bitmap sequentially from lsb to msb or msb to lsb;
   or
   K=number of SSBs in the default SSB pattern/number of SSBs in the active SSB pattern; first 1/K PRACH occasions amongst the PRACH occasions signaled by RACH configuration (PRACH configuration index) per PRACH configuration period are considered valid and others are considered as invalid.
The valid PRACH occasions determined based on the above rules are then mapped to transmitted SSBs of the active SSB pattern to determine PRACH occasion to SSB mapping.

In some embodiments, a default SSB pattern can be the first SSB pattern or SSB pattern with more transmitted SSBs or the default SSB pattern can be indicated by the network.

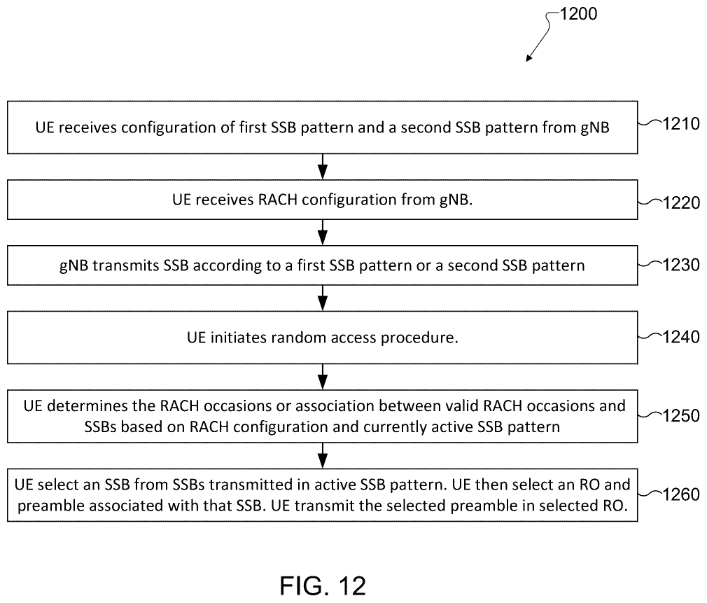

FIG. 12 illustrates another example procedure to determine valid RACH occasions 1200 according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a procedure to determine valid RACH occasions could be used without departing from the scope of this disclosure.

In the example of FIG. 12, procedure 1200 begins at step 1210. At step 1210, a UE (such as UE 116 of FIG. 1) receives configuration of a first SSB pattern and a second SSB pattern from a gNB (such as BS 102 of FIG. 1).

At step 1220, the UE receives a RACH configuration from the gNB.

At step 1230, the gNB transmits an SSB according to a first SSB pattern or a second SSB pattern.

At step 1240, the UE initiates random access procedure.

At step 1250, the UE determines the RACH occasions or association between valid RACH occasions and SSBs based on the RACH configuration and currently active SSB pattern.

At step 1260, the UEs select an SSB from SSBs transmitted in the active SSB pattern. The UE then selects a RACH occasion and preamble associated with that SSB. The UE transmits the selected preamble in the selected RACH occasion.

Although FIG. 12 illustrates one example procedure to determine valid RACH occasions 1200, various changes may be made to FIG. 12. For example, while shown as a series of steps, various steps in FIG. 12 could overlap, occur in parallel, occur in a different order, occur any number of times, be omitted, or replaced by other steps.

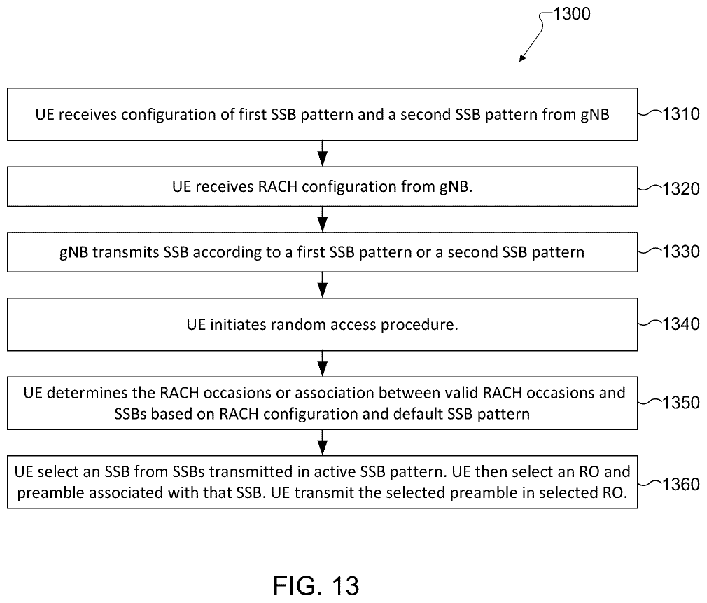

FIG. 13 illustrates another example procedure to determine valid RACH occasions 1300 according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a procedure to determine valid RACH occasions could be used without departing from the scope of this disclosure.

In the example of FIG. 13, procedure 1300 begins at step 1310. At step 1310, a UE (such as UE 116 of FIG. 1) receives configuration of a first SSB pattern and a second SSB pattern from a gNB (such as BS 102 of FIG. 1).

At step 1320, the UE receives a RACH configuration from the gNB.

At step 1330, the gNB transmits an SSB according to a first SSB pattern or a second SSB pattern.

At step 1340, the UE initiates a random access procedure.

At step 1350, the UE determines the RACH occasions or association between valid RACH occasions and SSBs based on the RACH configuration and default SSB pattern. The default SSB pattern can be the first SSB pattern or an SSB pattern with more transmitted SSBs or the default SSB pattern can be indicated by the network.

At step 1360, the UE selects an SSB from SSBs transmitted in the active SSB pattern. The UE then selects a RACH occasion and preamble associated with that SSB. The UE transmit the selected preamble in selected RACH occasion.

Although FIG. 13 illustrates one example procedure to determine valid RACH occasions 1300, various changes may be made to FIG. 13. For example, while shown as a series of steps, various steps in FIG. 13 could overlap, occur in parallel, occur in a different order, occur any number of times, be omitted, or replaced by other steps.

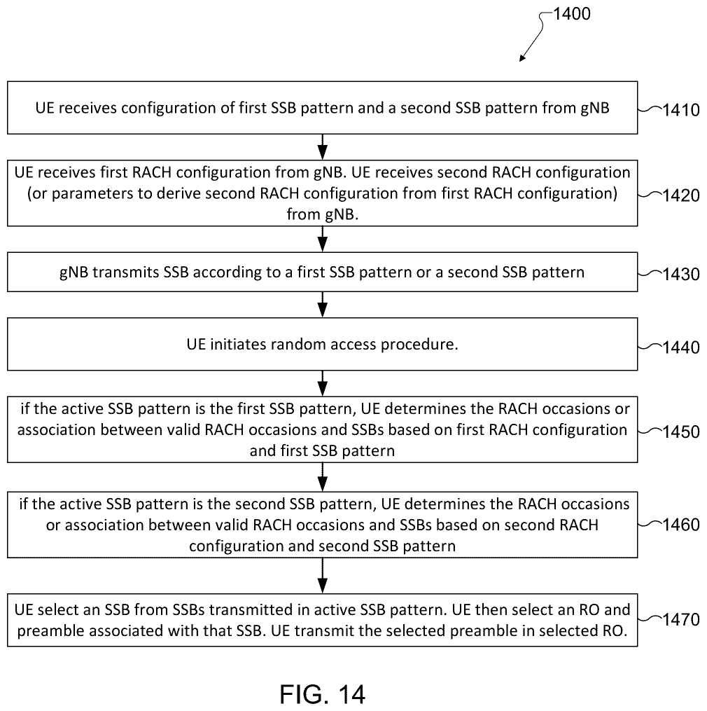

FIG. 14 illustrates another example procedure to determine valid RACH occasions 1400 according to embodiments of the present disclosure. An embodiment of the procedure illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a procedure to determine valid RACH occasions could be used without departing from the scope of this disclosure.

In the example of FIG. 14, procedure 1400 begins at step 1410. At step 1410, a UE (such as UE 116 of FIG. 1) receives configuration of a first SSB pattern and a second SSB pattern from a gNB (such as BS 102 of FIG. 1).

At step 1420, the UE receives a first RACH configuration from the gNB. The UE also receives a second RACH configuration (or parameters to derive second RACH configuration from first RACH configuration) from the gNB.

At step 1430, the gNB transmits an SSB according to a first SSB pattern or a second SSB pattern.

At step 1440, the UE initiates a random access procedure.

At step 1450, if the active SSB pattern is the first SSB pattern, The UE determines the RACH occasions or association between valid RACH occasions and SSBs based on the first RACH configuration and first SSB pattern.

At step 1460, if the active SSB pattern is the second SSB pattern, the UE determines the RACH occasions or association between valid RACH occasions and SSBs based on the second RACH configuration and second SSB pattern.

At step 1470, the UE selects an SSB from SSBs transmitted in the active SSB pattern. The UE then selects an RO and preamble associated with that SSB. The UE transmits the selected preamble in selected RO.

Although FIG. 14 illustrates one example procedure to determine valid RACH occasions 1400, various changes may be made to FIG. 14. For example, while shown as a series of steps, various steps in FIG. 14 could overlap, occur in parallel, occur in a different order, occur any number of times, be omitted, or replaced by other steps.

In current wireless network designs, the number of SSBs per RO and preambles per SSB is common for all transmitted SSBs. ssb-perRACH-OccasionAndCB-PreamblesPerSSB is signaled in a RACH-ConfigCommon by the gNB. ssb-perRACH-OccasionAndCB-PreamblesPerSSB indicates CB-PreamblesPerSSB (R) and ssb-perRACH-Occasion (N). This mechanism works when coverage of each SSB is the same and/or there is uniform distribution of UEs across the coverage of transmitted SSBs. In reality, coverage of each SSB can be different and/or there is non-uniform distribution of UEs across the coverage of transmitted SSBs. To address this one of the following options can be considered for non-uniform RACH resources:

In some embodiments, a gNB can signal (e.g., via system information or an RRC message) multiple instances of RACH-ConfigCommon. These multiple instances of RACH-ConfigCommon can be per BWP. Each RACH-ConfigCommon is associated to a subset of transmitted SSBs. A list/bitmap of SSBs associated with a RACH-ConfigCommon can be signaled (e.g., in a RACH-ConfigCommon IE). During random access procedure, the UE selects an SSB. The UE then selects a RACH configuration (i.e., a RACH-ConfigCommon corresponding to the selected SSB). The UE then applies the parameters in the selected RACH-ConfigCommon to determine a RACH occasion, preamble, etc. during the random access procedure.

In some embodiments, a gNB can signal (e.g., via system information or RRC message) multiple instances of ssb-perRACH-OccasionAndCB-PreamblesPerSSBs in a RACH-ConfigCommon IE. Each ssb-perRACH-OccasionAndCB-PreamblesPerSSBs is associated to a subset of transmitted SSBs. A list/bitmap of SSBs associated with each ssb-perRACH-OccasionAndCB-PreamblesPerSSBs can be signaled (e.g., in a RACH-ConfigCommon IE). One example is as follows:

| | |
|---|---|
| ssb-perRACH-OccasionAndCB-PreamblesPerSSBsList-r19 | SEQUENCE (SIZE(1..X-r19)) OF |
| ssb-perRACH-OccasionAndCB-PreamblesPerSSBs-r19 | OPTIONAL |
| ssb-perRACH-OccasionAndCB-PreamblesPerSSBs-r19 | SEQUENCE { |

ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| two | ENUMERATED {n4,n8,n12,n16,n20,n24,n28,n32}, |
|---|---|
| four | INTEGER (1..16), |
| eight | INTEGER (1..8), |
| sixteen | INTEGER (1..4) |
| } | |
| sdt-SSB-Subset-r19 | CHOICE { |
| shortBitmap-r19 | BIT STRING (SIZE (4)), |
| mediumBitmap-r19 | BIT STRING (SIZE (8)), |
| longBitmap-r19 | BIT STRING (SIZE (64)) |
| } | |
| } | |

In some embodiments, the network can signal the number of ROs and number of preambles for each subset of SSBs. The size of each subset can be one or more SSBs. Based on ssb-perRACH-Occasion for each set of transmitted SSBs, valid PRACH occasions (for paired spectrum or supplementary uplink band all PRACH occasions are valid) amongst the PRACH occasions configured by prach-ConfigurationIndex are mapped to SSBs. The UE maps transmitted SSBs to PRACH occasions in order of increasing SSB indexes. For example, assume four SSBs, SSB1, SSB2, SSB3 and SSB 4 are transmitted in a cell. There are four RACH occasions in the PRACH configuration period. ssb-perRACH-Occasion is 1 for SSB 1 and SSB 2. ssb-perRACH-Occasion is 2 for SSB 3 and SSB 4. The first RACH occasion in the PRACH configuration period is mapped to SSB1, the second RACH occasion in the PRACH configuration period is mapped to SSB2, the third RACH occasion in the PRACH configuration period is mapped to SSB 3 and SSB 4. If N<1, where N is ssb-perRACH-Occasion for an SSB, that SSB is mapped to 1/N consecutive valid PRACH occasions and R contention based preambles with consecutive indexes associated with the SSB per valid PRACH occasion start from preamble index 0, where R is the contention based preambles for that SSB. If N≥1, where N is ssb-perRACH-Occasion for an SSB, R contention based preambles (where R is the contention based preambles for that SSB) with consecutive indexes associated with SSB n, 0≤n≤N−1, per valid PRACH occasion start from preamble index n·N_{preamble}^{total}/N where N_{preamble}^{total} is provided by totalNumberOfRA-Preambles and is an integer multiple of N. totalNumberOfRA-Preambles is signaled by gNB in RACH configuration.

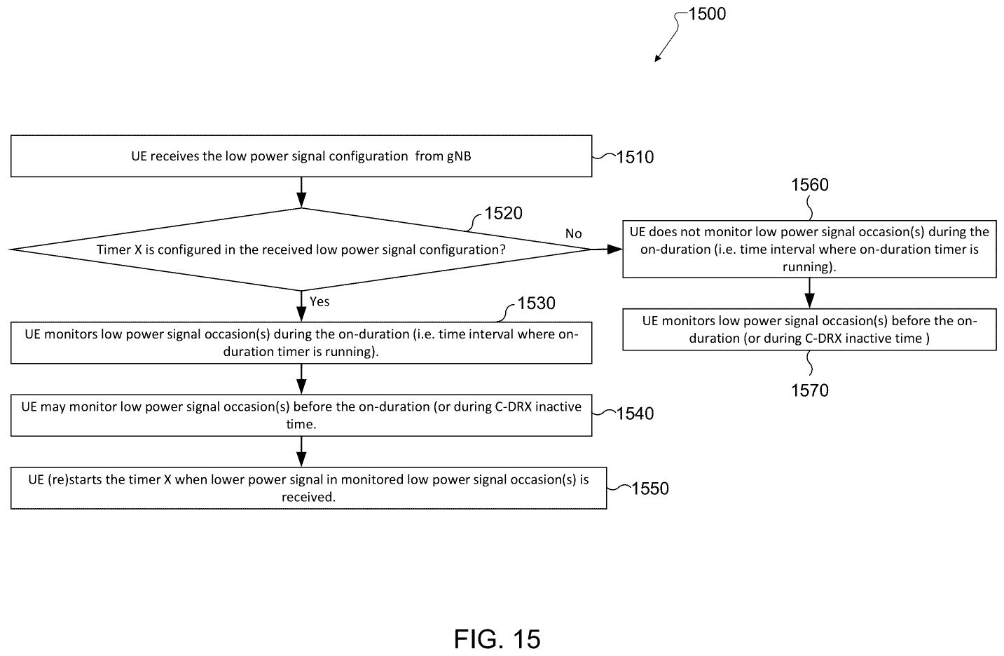

FIG. 15 illustrates an example procedure for LP-WUS operation 1500 according to embodiments of the present disclosure. An embodiment of the procedure illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a procedure for LP-WUS operation could be used without departing from the scope of this disclosure.

In the example of FIG. 15, procedure 1500 begins at step 1510. At step 1510, a UE (such as UE 116 of FIG. 1) receives a low power signal configuration (e.g., a low power wakeup signal configuration) from a gNB (such as BS 102 of FIG. 1) in an RRC message (e.g., RRCReconfiguration message). The low power signal configuration includes parameters to indicate time/frequency resources/occasions for monitoring a low power signal in the RRC_CONNECTED state. The RRC message may also configure C-DRX.

In some embodiments, at step 1520, if a timer “X” is configured in the received low power signal configuration, the UE performs operations as per an “approach 15-1” starting at step 1530. If the timer X is not configured in the received low power signal configuration, the UE perform operations as per an “approach 15-2” starting at step 1560.

Alternatively at step 1520, in some embodiments, if low power signal occasion(s) as per the low power signal configuration are located during a period where on-duration timer is running, the UE perform operations as per approach 15-1 starting at step 1530. Otherwise (i.e., if low power signal occasion(s) as per the low power signal configuration are not located during the period where the on-duration timer is running), the UE performs operations as per approach 15-2 starting at step 1560.

Approach 15-1: At step 1530, the UE monitors low power signal occasion(s) during the on-duration (i.e., time interval where on-duration timer is running). In some embodiments, in this approach the UE may monitor low power signal occasion(s) during a C-DRX inactive time (e.g., before the on-duration or in interval between time point A and start of on-duration timer where point A is at an offset before the start of on-duration timer) at step 1540. In some embodiments, in this approach the UE may not monitor low power signal occasion(s) during C-DRX inactive time at step 1540.

At step 1550, the UE (re)starts the timer X when lower power signal in monitored low power signal occasion(s) is received (or the UE (re)starts the timer X when a lower power signal in monitored low power signal occasion(s) is received and indicates for the UE to wake up/wakeup the main receiver). In an embodiment, timer X is started only when lower power signal in monitored low power signal occasion(s) is received during the on-duration (or the UE (re)starts the timer X when a lower power signal in monitored low power signal occasion(s) is received during the on-duration and indicates for the UE to wake up/wakeup the main receiver).
For the low power signal monitoring before on-duration, the UE starts the on-duration timer irrespective of whether a lower power signal is received.
   The UE starts the on-duration timer after drx-SlotOffset from the beginning of the subframe which satisfy [(SFN x 10)+subframe number] modulo (drx-LongCycle)=drx-StartOffset.
   If the Long DRX cycle is used for a DRX group and the drx-NonIntegerLongCycleStartOffset is not configured, and [(SFN×10)+subframe number] modulo (drx-LongCycle)=drx-StartOffset: the UE starts the on-duration timer after drx-SlotOffset from the beginning of the subframe.
   If the Long DRX cycle is used for a DRX group and the drx-NonIntegerLongCycleStartOffset is configured, and floor ([(DRX SFN COUNTER x 10240)+(SFN x 10)+subframe number] modulo (drx-NonIntegerLongCycle))=floor([(drx-TimeReferenceSFN x 10)+drx-StartOffset]modulo (drx-NonIntegerLongCycle)): the UE starts the on-duration timer after drx-SlotOffset from the beginning of the subframe.
   If the Short DRX cycle is used for a DRX group and the drx-NonIntegerShortCycle is not configured, and [(SFN×10)+subframe number] modulo (drx-ShortCycle)=(drx-StartOffset) modulo (drx-ShortCycle): the UE starts the on-duration timer after drx-SlotOffset from the beginning of the subframe.
   If the Short DRX cycle is used for a DRX group and the drx-NonIntegerShortCycle is configured, and floor([(DRX SFN COUNTER x 10240)+(SFN×10)+subframe number] modulo (drx-NonIntegerShortCycle))=floor([(drx-TimeReferenceSFN×10)+drx-StartOffset]modulo (drx-NonIntegerShortCycle)): the UE starts the on-duration timer after drx-SlotOffset from the beginning of the subframe.

Approach 15-2: At step 1560, the UE does not monitor for a low power signal during the on-duration. At step 1570, the UE monitors low power signal occasion(s) during C-DRX inactive time (e.g., before the on-duration or in interval between time point A and start of on-duration timer where point A is at an offset before the start of on-duration timer).
If a lower power signal in the monitored low power signal occasion(s) is received (or if a lower power signal in the monitored low power signal occasion(s) is received and indicates for the UE to wake up/wakeup the main receiver):
   The UE starts on-duration timer after drx-SlotOffset from the beginning of the subframe which satisfy [(SFN×10)+subframe number] modulo (drx-LongCycle)=drx-StartOffset.
   If the Long DRX cycle is used for a DRX group and the drx-NonIntegerLongCycleStartOffset is not configured, and [(SFN×10)+subframe number] modulo (drx-LongCycle)=drx-StartOffset: the UE the starts on-duration timer after drx-SlotOffset from the beginning of the subframe.
   If the Long DRX cycle is used for a DRX group and the drx-NonIntegerLongCycleStartOffset is configured, and floor ([(DRX SFN COUNTER×10240)+(SFN×10)+subframe number] modulo (drx-NonIntegerLongCycle))=floor([(drx-TimeReferenceSFN×10)+drx-StartOffset]modulo (drx-NonIntegerLongCycle)): the UE starts the on-duration timer after drx-SlotOffset from the beginning of the subframe.
   If the Short DRX cycle is used for a DRX group and the drx-NonIntegerShortCycle is not configured, and [(SFN×10)+subframe number] modulo (drx-ShortCycle)=(drx-StartOffset) modulo (drx-ShortCycle): the UE starts the on-duration timer after drx-SlotOffset from the beginning of the subframe.
   If the Short DRX cycle is used for a DRX group and the drx-NonIntegerShortCycle is configured, and floor([(DRX SFN COUNTER×10240)+(SFN×10)+subframe number] modulo (drx-NonIntegerShortCycle))=floor([(drx-TimeReferenceSFN×10)+drx-StartOffset]modulo (drx-NonIntegerShortCycle)): the UE starts the on-duration timer after drx-SlotOffset from the beginning of the subframe.

Although FIG. 15 illustrates one example procedure for LP-WUS operation 1500, various changes may be made to FIG. 15. For example, while shown as a series of steps, various steps in FIG. 15 could overlap, occur in parallel, occur in a different order, occur any number of times, be omitted, or replaced by other steps.

In some embodiments, a low power signal received during inactive time indicates whether the UE performs operations as per approach 15-1 or approach 15-2.

In some embodiments, if LPWUS occasion(s) as per the low power signal configuration overlap with a period where the on-duration timer is running, the UE perform operations as per approach 15-1; otherwise, the UE perform operations as per approach 15-2.

In some embodiments, the UE monitors low power signal occasion(s) during C-DRX inactive time (e.g., before the on-duration or in interval between time point A and start of on-duration timer where point A is at an offset before the start of on-duration timer). If the received low power signal indicates the UE to start timer X and timer X is configured:
The UE starts the timer X.
The UE starts the on-duration timer after drx-SlotOffset from the beginning of the subframe which satisfy [(SFN×10)+subframe number] modulo (drx-LongCycle)=drx-StartOffset.
If the Long DRX cycle is used for a DRX group and the drx-NonIntegerLongCycleStartOffset is not configured, and [(SFN×10)+subframe number] modulo (drx-LongCycle)=drx-StartOffset: the UE starts the on-duration timer after drx-SlotOffset from the beginning of the subframe
If the Long DRX cycle is used for a DRX group and the drx-NonIntegerLongCycleStartOffset is configured, and floor ([(DRX_SFN_COUNTER x 10240)+(SFN×10)+subframe number] modulo (drx-NonIntegerLongCycle))=floor([(drx-TimeReferenceSFN×10)+drx-StartOffset]modulo (drx-NonIntegerLongCycle)): The UE starts the on-duration timer after drx-SlotOffset from the beginning of the subframe.
If the Short DRX cycle is used for a DRX group and the drx-NonIntegerShortCycle is not configured, and [(SFN×10)+subframe number] modulo (drx-ShortCycle)=(drx-StartOffset) modulo (drx-ShortCycle): the UE starts the on-duration timer after drx-SlotOffset from the beginning of the subframe.
If the Short DRX cycle is used for a DRX group and the drx-NonIntegerShortCycle is configured, and floor([(DRX_SFN_COUNTER×10240)+(SFN×10)+subframe number] modulo (drx-NonIntegerShortCycle))=floor([(drx-TimeReferenceSFN×10)+drx-StartOffset]modulo (drx-NonIntegerShortCycle)): the UE starts the on-duration timer after drx-SlotOffset from the beginning of the subframe.
The UE monitors low power signal occasion(s) during the on-duration (i.e., time interval where on-duration timer is running).

Otherwise (if the received low power signal does not indicate for the UE to start timer X or indicates for the UE to start the on-duration timer only)
The UE starts on-duration timer after drx-SlotOffset from the beginning of the subframe which satisfy [(SFN×10)+subframe number] modulo (drx-LongCycle)=drx-StartOffset.
If the Long DRX cycle is used for a DRX group and the drx-NonIntegerLongCycleStartOffset is not configured, and [(SFN×10)+subframe number] modulo (drx-LongCycle)=drx-StartOffset: the UE starts the on-duration timer after drx-SlotOffset from the beginning of the subframe.
If the Long DRX cycle is used for a DRX group and the drx-NonIntegerLongCycleStartOffset is configured, and floor ([(DRX SFN COUNTER x 10240)+(SFN×10)+subframe number] modulo (drx-NonIntegerLongCycle))=floor([(drx-TimeReferenceSFN×10)+drx-StartOffset]modulo (drx-NonIntegerLongCycle)): the UE starts the on-duration timer after drx-SlotOffset from the beginning of the subframe.
If the Short DRX cycle is used for a DRX group and the drx-NonIntegerShortCycle is not configured, and [(SFN×10)+subframe number] modulo (drx-ShortCycle)=(drx-StartOffset) modulo (drx-ShortCycle): the UE starts the on-duration timer after drx-SlotOffset from the beginning of the subframe.
If the Short DRX cycle is used for a DRX group and the drx-NonIntegerShortCycle is configured, and floor([(DRX SFN COUNTER×10240)+(SFN×10)+subframe number] modulo (drx-NonIntegerShortCycle))=floor([(drx-TimeReferenceSFN×10)+drx-StartOffset]modulo (drx-NonIntegerShortCycle)): the UE starts the on-duration timer after drx-SlotOffset from the beginning of the subframe.
The UE does not monitor low power signal occasion(s) during the on-duration (i.e., the time interval where the on-duration timer is running).

In some embodiments, the UE can only be configured to monitor a low power signal when connected mode DRX is configured, and at occasion(s) at a configured offset before the on-duration. More than one monitoring occasion can be configured before the on-duration.

In some embodiments, the UE does not monitor low power signal on occasions occurring during measurement gaps, BWP switching, or when it monitors response for a CFRA preamble transmission for beam failure recovery, in which case it monitors the PDCCH during the next on-duration.

In some embodiments, when CA is configured, low power signal monitoring is only configured on the PCell.

In some embodiments, If approach 15-1 is configured (or the UE follows operations as per approach 15-1) and the On duration timer is running and Timer X is not running and other legacy C-DRX timers (e.g., inactivity timer, retransmission timer) are not running: the UE skips PDCCH monitoring of RNTIs (i.e., C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SL-CS-RNTI and SL Semi-Persistent Scheduling V-RNTI) whose monitoring is controlled by C-DRX.

In some embodiments, when DRX is configured, the Active Time for Serving Cells in a DRX group includes the time while:
drx-onDurationTimer or drx-InactivityTimer configured for the DRX group is running; or
drx-RetransmissionTimerDL, drx-RetransmissionTimerUL or drx-RetransmissionTimerSL is running on any Serving Cell in the DRX group; or
ra-ContentionResolutionTimer (as described in clause 5.1.5) or msgB-ResponseWindow (as described in clause 5.1.4a) is running; or
timer X is running; or
a Scheduling Request is sent on PUCCH and is pending. If this Serving Cell is part of a non-terrestrial network, the Active Time is started after the Scheduling Request transmission that is performed when the SR COUNTER is 0 for all the SR configurations with pending SR(s) plus the UE-gNB RTT; or
a PDCCH indicating a new transmission addressed to the C-RNTI of the MAC entity has not been received after successful reception of a Random Access Response for the Random Access Preamble not selected by the MAC entity among the contention-based Random Access Preamble (as described in clauses 5.1.4 and 5.1.4a); or
there is an ongoing RACH-less LTM cell switch; or
there is an ongoing RACH-less handover in a terrestrial network.

In an some embodiments, instead of a new Timer X, the inactivity timer can be used in operations described in this disclosure.

In some embodiments, if timer X is running and the on-duration timer is running
The UE monitors PDCCH (i.e., PDCCH monitoring of RNTIs (i.e., C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SL-CS-RNTI and SL Semi-Persistent Scheduling V-RNTI) whose monitoring is controlled by C-DRX).
The UE performs RRM/RLM/BFD.

In some embodiments, if timer X is not running and the on-duration timer is running
The UE does not monitor PDCCH (i.e., does not monitor PDCCH for RNTIs (i.e., C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SL-CS-RNTI and SL Semi-Persistent Scheduling V-RNTI) whose monitoring is controlled by C-DRX).
The UE performs RRM/RLM/BFD.

In some embodiments, if timer X is running and the on-duration timer is not running
The UE monitors PDCCH (i.e., PDCCH monitoring of RNTIs (i.e., C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SL-CS-RNTI and SL Semi-Persistent Scheduling V-RNTI) whose monitoring is controlled by C-DRX).
For RRM/RLM/BFD:
   In some embodiments, the UE performs RRM/RLM/BFD
   Alternatively, in some embodiments, the UE does not perform RRM/RLM/BFD
   Alternatively, in some embodiments, the UE performs RRM/RLM/BFD if indicated (by the gNB in an RRC message or LPWUS or low power signal) by the network
   Alternatively, in some embodiments, if any C-DRX timer (drx-onDurationTimer, drx-InactivityTimer, drx-RetransmissionTimerDL, drx-RetransmissionTimerUL or drx-RetransmissionTimerSL, ra-ContentionResolutionTimer, msgB-Response Window) is running (or the UE is in active time), the UE performs RRM/RLM/BFD. Otherwise, not.
   Alternatively, in some embodiments, the if the legacy C-DRX timer(s) running, the UE performs RRM/RLM/BFD.
   Alternatively, in some embodiments, if the legacy C-DRX timer(s) (drx-onDurationTimer, drx-InactivityTimer, drx-RetransmissionTimerDL, drx-RetransmissionTimerUL or drx-RetransmissionTimerSL, ra-ContentionResolutionTimer, msgB-ResponseWindow) are not running (or the UE is not in active time), the UE performs RRM/RLM/BFD if indicated (by the gNB in an RRC message or LPWUS or low power signal) by the network.

In some embodiments, if timer X is not running and the on-duration timer is not running if any C-DRX timer (drx-onDurationTimer, drx-InactivityTimer, drx-RetransmissionTimerDL, drx-RetransmissionTimerUL or drx-RetransmissionTimerSL, ra-ContentionResolutionTimer, msgB-Response Window) is running (or the UE is in active time), the UE monitors the PDCCH, and the UE performs RRM/RLM/BFD. Otherwise, not.

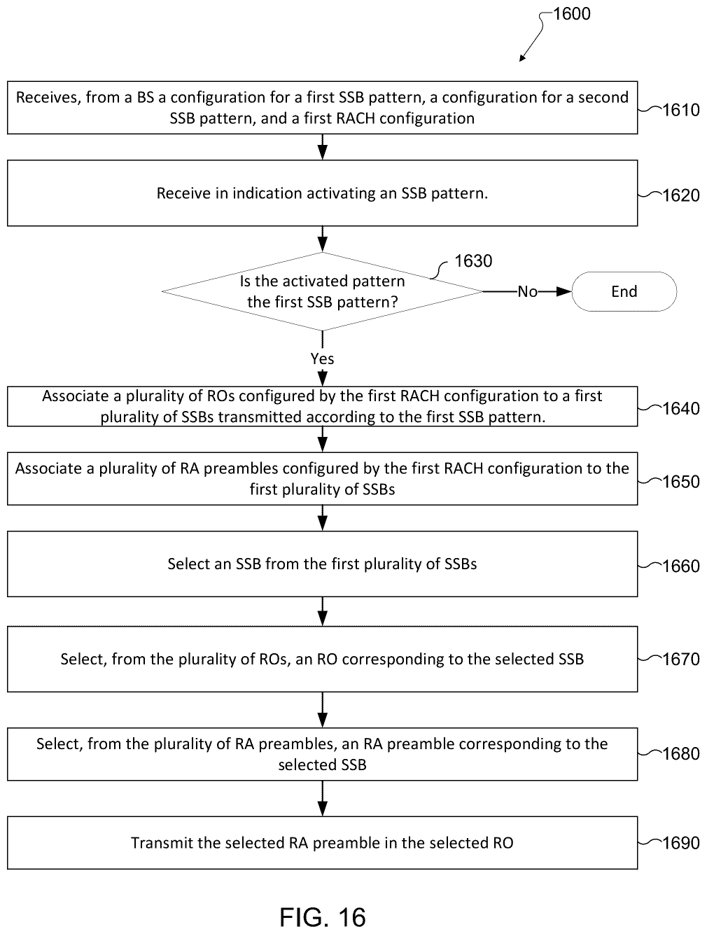

FIG. 16 illustrates an example method for adapting paging occasions 1600 according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments for adapting paging occasions could be used without departing from the scope of this disclosure.

In the example of FIG. 16, method 1600 begins at step 1610. At step 1610, a UE (such as UE 116 of FIG. 1) receives, from a BS (such as BS 102 of FIG. 1), a configuration for a first SSB pattern, a configuration for a second SSB pattern, and a first random access RACH configuration.

At step 1620, the UE receives, from the BS, an indication activating an SSB pattern.

At step 1630, the UE determines whether the activated SSB pattern is the first SSB pattern. If the activated SSB pattern is not the first SSB pattern, method 1600 ends. Otherwise, if the activated SSB pattern is the first SSB patter, method 1600 proceeds to step 1640.

At step 1640, the UE associates a plurality of ROs configured by the first RACH configuration to a first plurality of SSBs transmitted according to the first SSB pattern. In some embodiments, the association is based on a number of SSBs per RO included in the first RACH configuration.

At step 1650, the UE associates a plurality of RA preambles configured by the first RACH configuration to the first plurality of SSBs. In some embodiments, the association is based on a number of CBRA preambles per SSB included in the first RACH configuration.

At step 1660, the UE selects an SSB from the first plurality of SSBs.

At step 1670, the UE selects from the plurality of ROs, an RO corresponding to the selected SSB. In some embodiments, the selection is based on the association between the first plurality of SSBs to the plurality of ROs

At step 1680, the UE selects, from the plurality of RA preambles, an RA preamble corresponding to the selected SSB. In some embodiments, the selection is based on the association between the first plurality of SSBs to the plurality of RA preambles.

At step 1690, the UE transmits the selected RA preamble in the selected RO.

In some embodiments, the UE may also determine whether the activated SSB pattern is the second SSB pattern.

In some embodiments, in response to a determination that the activated SSB pattern is the second SSB pattern, the UE may: associate a plurality of ROs configured by the first RACH configuration to a second plurality of SSBs transmitted according to the second SSB pattern, wherein the association is based on a number of SSBs per RO included in the first RACH configuration; associate a plurality of RA preambles configured by the first RACH configuration to the second plurality of SSBs, wherein the association is based on a number of CBRA preambles per SSB included in the first RACH configuration; select an SSB from the first plurality of SSBs; select, from the plurality of ROs, an RO corresponding to the selected SSB based on the association between first plurality of SSBs to the plurality of ROs; selecting, from the plurality of RA preambles, an RA preamble corresponding to the selected SSB based on the association between the first plurality of SSBs to the plurality of RA preambles; and transmitting the selected RA preamble in the selected RO.

In some embodiments, in response to a determination that the activated SSB pattern is the second SSB pattern, the UE may: associate a plurality of ROs configured by the first RACH configuration to the first plurality of SSBs transmitted according to the first SSB pattern, wherein the association is based on a number of SSBs per RO included in the first RACH configuration; associate a plurality of RA preambles configured by the first RACH configuration to the first plurality of SSBs, wherein the association is based on a number of CBRA preambles per SSB included in the first RACH configuration; select an SSB from a second plurality of SSBs transmitted according to the second SSB pattern; select, from the plurality of ROs, an RO corresponding to the selected SSB based on the association between plurality of SSBs to the plurality of ROs; select, from the plurality of RA preambles, an RA preamble corresponding to the selected SSB based on the association between the first plurality of SSBs to the plurality of RA preambles; and transmit the selected RA preamble in the selected RO.

In some embodiments, the UE may receive, from the BS, a second RACH configuration. In some embodiments, in response to a determination that the activated SSB pattern is the second SSB pattern, the UE may: associate a plurality of ROs configured by the second RACH configuration to a second plurality of SSBs transmitted according to the second SSB pattern, wherein the association is based on a number of SSBs per RO included in the second RACH configuration; associate a plurality of RA preambles configured by the second RACH configuration to the second plurality of SSBs, wherein the association is based on a number of CBRA preambles per SSB included in the second RACH configuration; select an SSB from the plurality of SSBs; select, from the plurality of ROs, an RO corresponding to the selected SSB based on the association between the second plurality of SSBs to the plurality of ROs; select from the plurality of RA preambles, an RA preamble corresponding to the selected SSB based on the association between the second plurality of SSBs to the plurality of RA preambles; and transmit the selected RA preamble in the selected RO.

In some embodiments, the UE may receive, from the BS, a first paging configuration, and determining whether the activated SSB pattern is the first SSB pattern or the second SSB pattern. In response to a determination that the activated SSB pattern is the first SSB pattern, the UE may: determine a paging occasion based on a number of SSBs transmitted according to the first SSB pattern and the first paging configuration, wherein PDCCH monitoring occasions for paging in the determined paging occasion are mapped to the first plurality of SSBs; and monitor at least one PDCCH monitoring occasion for a paging in the determined paging occasion. In response to a determination that the activated SSB pattern is the second SSB pattern the UE may: determine a paging occasion based on a number of SSBs transmitted according to the second SSB pattern and the first paging configuration, wherein PDCCH monitoring occasions for paging in the determined paging occasion are mapped to a second plurality of SSBs transmitted according to the second SSB pattern; and monitor at least one PDCCH monitoring occasion for a paging in the determined paging occasion.

In some embodiments, the UE may receive, from the BS, a first paging configuration, and determining whether the activated SSB pattern is the first SSB pattern or the second SSB pattern. In response to a determination that the activated SSB pattern is the first SSB pattern, the UE may: determine a paging occasion based on a number of SSBs transmitted according to the first SSB pattern and the first paging configuration, wherein PDCCH monitoring occasions for paging in the determined paging occasion are mapped to the first plurality of SSBs; and monitor at least one PDCCH monitoring occasion for a paging in the determined paging occasion. In response to a determination that the activated SSB pattern is the second SSB pattern the UE may: determine a paging occasion based on a number of SSBs transmitted according to the first SSB pattern and the first paging configuration, wherein PDCCH monitoring occasions for paging in the determined paging occasion are mapped to the first plurality of SSBs; and monitor at least one PDCCH monitoring occasion mapped to a second plurality of SSBs transmitted according to the second SSB pattern for a paging in the determined paging occasion.

In some embodiments, the UE may receive, from the BS, a first paging configuration, and determining whether the activated SSB pattern is the first SSB pattern or the second SSB pattern. In response to a determination that the activated SSB pattern is the first SSB pattern, the UE may: determine a paging occasion based on a number of SSBs transmitted according to the first SSB pattern and the first paging configuration, wherein PDCCH monitoring occasions for paging in the determined paging occasion are mapped to the first plurality of SSBs; and monitor at least one PDCCH monitoring occasion for a paging in the determined paging occasion. In response to a determination that the activated SSB pattern is the second SSB pattern the UE may: determine a paging occasion based on a number of SSBs transmitted according to the second SSB pattern and the second paging configuration, wherein PDCCH monitoring occasions for paging in the determined paging occasion are mapped to a second plurality of SSBs transmitted according to the second SSB pattern; and monitor at least one PDCCH monitoring occasion for a paging in the determined paging occasion.

Although FIG. 16 illustrates one example method for adapting paging occasions 1600, various changes may be made to FIG. 16. For example, while shown as a series of steps, various steps in FIG. 16 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive, from a base station (BS), a configuration for a first synchronization signal block (SSB) pattern, a configuration for a second SSB pattern, and a first random access (RA) channel (RACH) configuration; and
receive from the BS, an indication activating an SSB pattern; and
a processor operatively coupled to the transceiver, the processor configured to:
determine whether the activated SSB pattern is the first SSB pattern; and
in response to a determination that the activated SSB pattern is the first SSB pattern:
associate a plurality of RA occasions (ROs) configured by the first RACH configuration to a first plurality of SSBs transmitted according to the first SSB pattern, wherein the association is based on a number of SSBs per RO included in the first RACH configuration;
associate a plurality of RA preambles configured by the first RACH configuration to the first plurality of SSBs, wherein the association is based on a number of contention based random access (CBRA) preambles per SSB included in the first RACH configuration;
select an SSB from the first plurality of SSBs;
select, from the plurality of ROs, an RO corresponding to the selected SSB based on the association between first plurality of SSBs to the plurality of ROs;
select, from the plurality of RA preambles, an RA preamble corresponding to the selected SSB based on the association between the first plurality of SSBs to the plurality of RA preambles; and
cause the transceiver to transmit the selected RA preamble in the selected RO.

2. The UE of claim 1, wherein the processor is further configured to:
determine whether the activated SSB pattern is the second SSB pattern; and
in response to a determination that the activated SSB pattern is the second SSB pattern:
associate a plurality of ROs configured by the first RACH configuration to a second plurality of SSBs transmitted according to the second SSB pattern, wherein the association is based on a number of SSBs per RO included in the first RACH configuration;
associate a plurality of RA preambles configured by the first RACH configuration to the second plurality of SSBs, wherein the association is based on a number of CBRA preambles per SSB included in the first RACH configuration;
select an SSB from the second plurality of SSBs;
select, from the plurality of ROs, an RO corresponding to the selected SSB based on the association between second plurality of SSBs to the plurality of ROs;
select, from the plurality of RA preambles, an RA preamble corresponding to the selected SSB based on the association between the second plurality SSBs to the plurality of RA preambles; and
cause the transceiver to transmit the selected RA preamble in the selected RO.

3. The UE of claim 1, wherein the processor is further configured to:
determine whether the activated SSB pattern is the second SSB pattern; and
in response to a determination that the activated SSB pattern is the second SSB pattern:
associate a plurality of ROs configured by the first RACH configuration to the first plurality of SSBs transmitted according to the first SSB pattern, wherein the association is based on a number of SSBs per RO included in the first RACH configuration;
associate a plurality of RA preambles configured by the first RACH configuration to the first plurality of SSBs, wherein the association is based on a number of CBRA preambles per SSB included in the first RACH configuration;
select an SSB from a second plurality of SSBs transmitted according to the second SSB pattern;
select, from the plurality of ROs, an RO corresponding to the selected SSB based on the association between first plurality of SSBs to the plurality of ROs;
select, from the plurality of RA preambles, an RA preamble corresponding to the selected SSB based on the association between the first plurality of SSBs to the plurality of RA preambles; and
cause the transceiver to transmit the selected RA preamble in the selected RO.

4. The UE of claim 1, wherein:
the transceiver is further configured to receive, from the BS, a second RACH configuration; and
the processor is further configured to:
determine whether the activated SSB pattern is the second SSB pattern; and
in response to a determination that the activated SSB pattern is the second SSB pattern:
associate a plurality of ROs configured by the second RACH configuration to a second plurality of SSBs transmitted according to the second SSB pattern, wherein the association is based on a number of SSBs per RO included in the second RACH configuration;
associate a plurality of RA preambles configured by the second RACH configuration to the second plurality of SSBs, wherein the association is based on a number of CBRA preambles per SSB included in the second RACH configuration;
select an SSB from the second plurality of SSBs;
select, from the plurality of ROs, an RO corresponding to the selected SSB based on the association between second plurality of SSBs to the plurality of ROs;
select, from the plurality of RA preambles, an RA preamble corresponding to the selected SSB based on the association between the second plurality of SSBs to the plurality of RA preambles; and
cause the transceiver to transmit the selected RA preamble in the selected RO.

5. The UE of claim 1, wherein:
the transceiver is further configured to receive, from the BS, a first paging configuration; and
the processor is further configured to:
determine whether the activated SSB pattern is the first SSB pattern or the second SSB pattern;
in response to a determination that the activated SSB pattern is the first SSB pattern:
determine a paging occasion based on a number of SSBs transmitted according to the first SSB pattern and the first paging configuration, wherein physical downlink control channel (PDCCH) monitoring occasions for paging in the determined paging occasion are mapped to the first plurality of SSBs; and
monitor at least one PDCCH monitoring occasion for a paging in the determined paging occasion; and
in response to a determination that the activated SSB pattern is the second SSB pattern:
determine a paging occasion based on a number of SSBs transmitted according to the second SSB pattern and the first paging configuration, wherein PDCCH monitoring occasions for paging in the determined paging occasion are mapped to a second plurality of SSBs transmitted according to the second SSB pattern; and
monitor at least one PDCCH monitoring occasion for a paging in the determined paging occasion.

6. The UE of claim 1, wherein:
the transceiver is further configured to receive, from the BS, a first paging configuration; and
the processor is further configured to:
determine whether the activated SSB pattern is the first SSB pattern or the second SSB pattern;
in response to a determination that the activated SSB pattern is the first SSB pattern:
determine a paging occasion based on a number of SSBs transmitted according to the first SSB pattern and the first paging configuration, wherein physical downlink control channel (PDCCH) monitoring occasions for paging in the determined paging occasion are mapped to the first plurality of SSBs; and
monitor at least one PDCCH monitoring occasion for a paging in the determined paging occasion; and
in response to a determination that the activated SSB pattern is the second SSB pattern:
determine a paging occasion based on a number of SSBs transmitted according to the first SSB pattern and the first paging configuration, wherein PDCCH monitoring occasions for paging in the determined paging occasion are mapped to the first plurality of SSBs; and
monitor at least one PDCCH monitoring occasion mapped to a second plurality of SSBs transmitted according to the second SSB pattern for a paging in the determined paging occasion.

7. The UE of claim 1, wherein:
the transceiver is further configured to receive, from the BS, a first paging configuration and a second paging configuration; and
the processor is further configured to:
determine whether the activated SSB pattern is the first SSB pattern or the second SSB pattern;
in response to a determination that the activated SSB pattern is the first SSB pattern:
determine a paging occasion based on a number of SSBs transmitted according to the first SSB pattern and the first paging configuration, wherein physical downlink control channel (PDCCH) monitoring occasions for paging in the determined paging occasion are mapped to the first plurality of SSBs; and
monitor at least one PDCCH monitoring occasion for a paging in the determined paging occasion; and
in response to a determination that the activated SSB pattern is the second SSB pattern:
determine a paging occasion based on a number of SSBs transmitted according to the second SSB pattern and the second paging configuration, wherein physical downlink control channel (PDCCH) monitoring occasions for paging in the determined paging occasion are mapped to a second plurality of SSBs transmitted according to the second SSB pattern; and
monitor at least one PDCCH monitoring occasion for a paging in the determined paging occasion.

8. Abase station (BS) comprising:
a transceiver configured to:
transmit a configuration for a first synchronization signal block (SSB) pattern, a configuration for a second SSB pattern, and a first random access (RA) channel (RACH) configuration; and
transmit an indication activating an SSB pattern; and
a processor operatively coupled to the transceiver, the processor configured to:
determine whether the activated SSB pattern is the first SSB pattern; and
in response to a determination that the activated SSB pattern is the first SSB pattern:
associate a first plurality of RA occasions (ROs) configured by the first RACH configuration to a first plurality of SSBs transmitted according to the first SSB pattern, wherein the association is based on a number of SSBs per RO included in the first RACH configuration;
associate a first plurality of RA preambles configured by the first RACH configuration to the first plurality of SSBs, wherein the association is based on a number of contention based random access (CBRA) preambles per SSB included in the first RACH configuration; and
monitor the plurality of ROs for an RA preamble from the plurality of RA preambles.

9. The BS of claim 8, wherein the processor is further configured to:
determine whether the activated SSB pattern is the second SSB pattern; and
in response to a determination that the activated SSB pattern is the second SSB pattern:
associate a plurality of ROs configured by the first RACH configuration to a second plurality of SSBs transmitted according to the second SSB pattern, wherein the association is based on a number of SSBs per RO included in the first RACH configuration;
associate a plurality of RA preambles configured by the first RACH configuration to the second plurality of SSBs, wherein the association is based on a number of CBRA preambles per SSB included in the first RACH configuration; and
monitor the plurality of ROs for an RA preamble from the plurality of RA preambles.

10. The BS of claim 8, wherein the processor is further configured to:
determine whether the activated SSB pattern is the second SSB pattern; and
in response to a determination that the activated SSB pattern is the second SSB pattern:
associate a plurality of ROs configured by the first RACH configuration to the first plurality of SSBs transmitted according to the first SSB pattern, wherein the association is based on a number of SSBs per RO included in the first RACH configuration;
associate a plurality of RA preambles configured by the first RACH configuration to the first plurality of SSBs, wherein the association is based on a number of CBRA preambles per SSB included in the first RACH configuration; and
monitor the plurality of ROs for an RA preamble from the plurality of RA preambles.

11. The BS of claim 8, wherein:
the transceiver is further configured to transmit a second RACH configuration; and
the processor is further configured to:
determine whether the activated SSB pattern is the second SSB pattern; and
in response to a determination that the activated SSB pattern is the second SSB pattern:
associate a plurality of ROs configured by the second RACH configuration to a second plurality of SSBs transmitted according to the second SSB pattern, wherein the association is based on a number of SSBs per RO included in the second RACH configuration;
associate a plurality of RA preambles configured by the second RACH configuration to the second plurality of SSBs, wherein the association is based on a number of CBRA preambles per SSB included in the second RACH configuration; and
monitor the plurality of ROs for an RA preamble from the plurality of RA preambles.

12. The BS of claim 8, wherein:
the transceiver is further configured to transmit a first paging configuration; and
the processor is further configured to:
determine whether the activated SSB pattern is the first SSB pattern or the second SSB pattern;
in response to a determination that the activated SSB pattern is the first SSB pattern:
determine a paging occasion based on a number of SSBs transmitted according to the first SSB pattern and the first paging configuration, wherein physical downlink control channel (PDCCH) monitoring occasions for paging in the determined paging occasion are mapped to the first plurality of SSBs; and
transmit a paging in the determined paging occasion; and
in response to a determination that the activated SSB pattern is the second SSB pattern:
determine a paging occasion based on a number of SSBs transmitted according to the second SSB pattern and the first paging configuration, wherein PDCCH monitoring occasions for paging in the determined paging occasion are mapped to a second plurality of SSBs transmitted according to the second SSB pattern; and
transmit a paging in the determined paging occasion.

13. The BS of claim 8, wherein:
the transceiver is further configured to transmit a first paging configuration; and
the processor is further configured to:
determine whether the activated SSB pattern is the first SSB pattern or the second SSB pattern;
in response to a determination that the activated SSB pattern is the first SSB pattern:
determine a paging occasion based on a number of SSBs transmitted according to the first SSB pattern and the first paging configuration, wherein physical downlink control channel (PDCCH) monitoring occasions for paging in the determined paging occasion are mapped to the first plurality of SSBs; and
transmit a paging in the determined paging occasion; and
in response to a determination that the activated SSB pattern is the second SSB pattern:
determine a paging occasion based on a number of SSBs transmitted according to the first SSB pattern and the first paging configuration, wherein PDCCH monitoring occasions for paging in the determined paging occasion are mapped to the first plurality of SSBs; and
transmit a paging in the determined paging occasion.

14. A method of operating a user equipment (UE), the method comprising:
receiving, from a base station (BS), a configuration for a first synchronization signal block (SSB) pattern, a configuration for a second SSB pattern, and a first random access (RA) channel (RACH) configuration;
receiving from the BS, an indication activating an SSB pattern;
determining whether the activated SSB pattern is the first SSB pattern; and
in response to a determination that the activated SSB pattern is the first SSB pattern:
associating a plurality of RA occasions (ROs) configured by the first RACH configuration to a first plurality of SSBs transmitted according to the first SSB pattern, wherein the association is based on a number of SSBs per RO included in the first RACH configuration;
associating a plurality of RA preambles configured by the first RACH configuration to the first plurality of SSBs, wherein the association is based on a number of contention based random access (CBRA) preambles per SSB included in the first RACH configuration;
selecting an SSB from the first plurality of SSBs;
selecting, from the plurality of ROs, an RO corresponding to the selected SSB based on the association between first plurality of SSBs to the plurality of ROs;
selecting, from the plurality of RA preambles, an RA preamble corresponding to the selected SSB based on the association between the first plurality of SSBs to the plurality of RA preambles; and
transmitting the selected RA preamble in the selected RO.

15. The method of claim 14, further comprising:
determining whether the activated SSB pattern is the second SSB pattern; and
in response to a determination that the activated SSB pattern is the second SSB pattern:
associating a plurality of ROs configured by the first RACH configuration to a second plurality of SSBs transmitted according to the second SSB pattern, wherein the association is based on a number of SSBs per RO included in the first RACH configuration;
associating a plurality of RA preambles configured by the first RACH configuration to the second plurality of SSBs, wherein the association is based on a number of CBRA preambles per SSB included in the first RACH configuration;
selecting an SSB from the second plurality of SSBs;
selecting, from the plurality of ROs, an RO corresponding to the selected SSB based on the association between second plurality of SSBs to the plurality of ROs;
selecting, from the plurality of RA preambles, an RA preamble corresponding to the selected SSB based on the association between the second plurality SSBs to the plurality of RA preambles; and
transmitting the selected RA preamble in the selected RO.

16. The method of claim 14, further comprising:
determining whether the activated SSB pattern is the second SSB pattern; and
in response to a determination that the activated SSB pattern is the second SSB pattern:
associating a plurality of ROs configured by the first RACH configuration to the first plurality of SSBs transmitted according to the first SSB pattern, wherein the association is based on a number of SSBs per RO included in the first RACH configuration;
associating a plurality of RA preambles configured by the first RACH configuration to the first plurality of SSBs, wherein the association is based on a number of CBRA preambles per SSB included in the first RACH configuration;
selecting an SSB from a second plurality of SSBs transmitted according to the second SSB pattern;
selecting, from the plurality of ROs, an RO corresponding to the selected SSB based on the association between plurality of SSBs to the plurality of ROs;
selecting, from the plurality of RA preambles, an RA preamble corresponding to the selected SSB based on the association between the first plurality of SSBs to the plurality of RA preambles; and
transmitting the selected RA preamble in the selected RO.

17. The method of claim 14, further comprising:
receiving, from the BS, a second RACH configuration;
determining whether the activated SSB pattern is the second SSB pattern; and
in response to a determination that the activated SSB pattern is the second SSB pattern:
associating a plurality of ROs configured by the second RACH configuration to a second plurality of SSBs transmitted according to the second SSB pattern, wherein the association is based on a number of SSBs per RO included in the second RACH configuration;
associating a plurality of RA preambles configured by the second RACH configuration to the second plurality of SSBs, wherein the association is based on a number of CBRA preambles per SSB included in the second RACH configuration;
selecting an SSB from the plurality of SSBs;
selecting, from the plurality of ROs, an RO corresponding to the selected SSB based on the association between the second plurality of SSBs to the plurality of ROs;
selecting, from the plurality of RA preambles, an RA preamble corresponding to the selected SSB based on the association between the second plurality of SSBs to the plurality of RA preambles; and
transmitting the selected RA preamble in the selected RO.

18. The method of claim 14, further comprising:
receiving, from the BS, a first paging configuration;
determining whether the activated SSB pattern is the first SSB pattern or the second SSB pattern;
in response to a determination that the activated SSB pattern is the first SSB pattern:
determining a paging occasion based on a number of SSBs transmitted according to the first SSB pattern and the first paging configuration, wherein physical downlink control channel (PDCCH) monitoring occasions for paging in the determined paging occasion are mapped to the first plurality of SSBs; and
monitoring at least one PDCCH monitoring occasion for a paging in the determined paging occasion; and
in response to a determination that the activated SSB pattern is the second SSB pattern:
determining a paging occasion based on a number of SSBs transmitted according to the second SSB pattern and the first paging configuration, wherein PDCCH monitoring occasions for paging in the determined paging occasion are mapped to a second plurality of SSBs transmitted according to the second SSB pattern; and
monitoring at least one PDCCH monitoring occasion for a paging in the determined paging occasion.

19. The method of claim 14, further comprising:
receiving, from the BS, a first paging configuration;
determining whether the activated SSB pattern is the first SSB pattern or the second SSB pattern;
in response to a determination that the activated SSB pattern is the first SSB pattern:
determining a paging occasion based on a number of SSBs transmitted according to the first SSB pattern and the first paging configuration, wherein physical downlink control channel (PDCCH) monitoring occasions for paging in the determined paging occasion are mapped to the first plurality of SSBs; and
monitoring at least one PDCCH monitoring occasion for a paging in the determined paging occasion; and
in response to a determination that the activated SSB pattern is the second SSB pattern:
determining a paging occasion based on a number of SSBs transmitted according to the first SSB pattern and the first paging configuration, wherein PDCCH monitoring occasions for paging in the determined paging occasion are mapped to the first plurality of SSBs; and
monitoring at least one PDCCH monitoring occasion mapped to a second plurality of SSBs transmitted according to the second SSB pattern for a paging in the determined paging occasion.

20. The method of claim 14, further comprising:
receiving, from the BS, a first paging configuration and a second paging configuration;
determining whether the activated SSB pattern is the first SSB pattern or the second SSB pattern;
in response to a determination that the activated SSB pattern is the first SSB pattern:
determining a paging occasion based on a number of SSBs transmitted according to the first SSB pattern and the first paging configuration, wherein physical downlink control channel (PDCCH) monitoring occasions for paging in the determined paging occasion are mapped to the first plurality of SSBs; and
monitoring at least one PDCCH monitoring occasion for a paging in the determined paging occasion; and
in response to a determination that the activated SSB pattern is the second SSB pattern:
determining a paging occasion based on a number of SSBs transmitted according to the second SSB pattern and the second paging configuration, wherein PDCCH monitoring occasions for paging in the determined paging occasion are mapped to a second plurality of SSBs transmitted according to the second SSB pattern; and
monitoring at least one PDCCH monitoring occasion for a paging in the determined paging occasion.
